(19) United States
(12) Patent Application Publication
(10) Pub. No.: US 2011/0042624 A1
(43) Pub. Date: Feb. 24, 2011

(54) METHOD FOR PRODUCING CONDUCTIVE THERMOPLASTIC ELASTOMER COMPOSITION AND CONDUCTIVE ROLLER COMPOSED OF SAME

(76) Inventor: Akira MINAGOSHI, Hyogo (JP)

Correspondence Address: BIRCH STEWART KOLASCH & BIRCH, PO BOX 747, FALLS CHURCH, VA, 22040-0747, US

(21) Appl. No.: 12/938,874

(22) Filed: Nov. 3, 2010

Related U.S. Application Data
(62) Division of application No. 12/155,753, filed on Jun. 9, 2008.

(30) Foreign Application Priority Data
Jun. 12, 2007 (JP) 2007-155152

(51) Int. Cl. H01B 1/12

(52) U.S. Cl. 252/500

(57) ABSTRACT

A conductive thermoplastic elastomer composition including a continuous phase and first and second uncontinuous phases. The continuous phase and the first and second uncontinuous phases form a sea-island structure; and the first and second uncontinuous phases independently forming island structures. In this structure, the continuous phase contains a composition which is a mixture of a thermoplastic elastomer and a thermoplastic resin; the first continuous phase contains a rubber component (B) containing at least one of diene rubber and ethylene-propylene-diene rubber; and the second continuous phase contains an ethylene oxide-propylene oxide-allyl glycidyl ether copolymer containing an anion-containing salt having a fluoro group and a sulfonyl group (component (C)).

### CROSS REFERENCE

This application is a Divisional of application Ser. No. 12/155,753, filed on Jun. 9, 2008. application Ser. No. 12/155,753 claims priority under 35 U.S.C. §119(a) of Japanese Patent Application No. 2007-155152 filed on Jun. 12, 2007, the entire contents of which are hereby incorporated by reference.

### BACKGROUND OF THE INVENTION

1. Field of the Invention

The present invention relates to a method of producing a conductive thermoplastic elastomer composition, and a conductive roller composed of the conductive thermoplastic elastomer composition and more particularly to a conductive roller useful as a transfer roller mounted in an image-forming apparatus.

2. Description of the Related Art

It is necessary for the conductive roller mounted in an image-forming apparatus such as a transfer roller, a driving roller, a developing roller, a charging roller, and the like to have a proper and stable electric resistance value.

As conventional methods of imparting conductivity to the conductive roller of this kind, the following two methods are conventionally used: In one known method, an electroconductive polymer composition containing a conductive filler such as powder of metal oxides, carbon black or the like in a polymer thereof is used. In the other known method, an ionic-conductive polymer composition such as urethane rubber, acrylonitrile butadiene rubber, epichlorohydrin rubber or the like is used.

In the case where the electroconductive polymer composition is used for the conductive roller, there is a region in which the electric resistance of the conductive roller changes rapidly owing to a slight change of an addition amount of the conductive filler. Thus it is very difficult to control the electric resistance of the conductive roller. In addition, because it is difficult to uniformly disperse the conductive filler in the polymer, the electric resistance value has variations in the circumferential and widthwise directions of the conductive roller.

The electric resistance value of the conductive roller using the electroconductive polymer composition depends on a voltage applied thereto. In particular, in the case where the carbon black is used as the conductive filler, the electric resistance value of the conductive roller depends greatly on the voltage applied thereto. Further when the electroconductive polymer composition contains a very large amount of the conductive filler such as the carbon black, it is difficult to mold the electroconductive polymer composition.

The conductive roller using the electroconductive polymer composition has the above-described problems. Recently, a high-quality image-forming technique including a digital image processing technique and color image processing technique has remarkably progressed. Thus there is a tendency that the ionic-conductive polymer composition is used preferentially to the electroconductive polymer composition.

Mostly the ionic-conductive polymer composition is used as a vulcanized rubber composition to form the conductive roller. But the vulcanized rubber composition is not thermoplastic and cannot be recycled.

When a conventional ionic-conductive agent is used, it is difficult to effectively decrease the electric resistance of the conductive roller. When a large amount of the ionic-conductive agent is contained in the polymer composition to solve this problem, bleeding occurs and mechanical properties such as the compression set, hardness, and the like of the composition composing the conductive roller deteriorate.

To overcome the above-described problem, the present applicant developed a conductive polymer composition which has rubber-like durability, elasticity, and flexibility, and resin-like moldability, is recyclable, and has a low electric resistance.

More specifically, as disclosed in Japanese Patent Application Laid-Open Nos. 2004-51829 (patent document 1) and 2004-269854 (patent document 2), the present applicant proposed the dynamically crosslinked conductive thermoplastic elastomer composition which is formed by adding the polymer having the ether or ester structure and the anion-containing salt having the fluoro group and the sulfonyl group to the elastomer composition in which the crosslinkable rubber or/and the thermoplastic elastomer are dynamically crosslinked and dispersed in the thermoplastic resin or/and the thermoplastic elastomer. They also proposed the conductive roller composed of the dynamically crosslinked conductive thermoplastic elastomer composition.

But the above-described conventional art has room for improvement from the standpoint of the electric resistance value of the conductive polymer composition. That is, it is preferable that the electric resistance value thereof can be set widely according to a use. When the conductive polymer composition is used as the conductive member of an image-forming apparatus, the conductive polymer composition is desired to have a low initial electric resistance value. When the electric resistance value changes greatly at the time of a continuous application of a voltage, a defective image is formed and so on. That is, it is impossible to reliably maintain the image quality. Thus the conductive polymer composition is desired to have a small change in the electric resistance value thereof at the time of the continuous application of a voltage.

The conductive roller does not have any problems when it is used in the neighborhood of a normal temperature. But the hardness of the conductive roller is a little high when it is used in a low-temperature environment. Thus when the conductive roller is used as a transfer roller, the conductive roller causes a decrease in the adhesiveness of a roller to paper. Thereby in some cases, a defective image is generated because the toner is not exactly transferred to the paper. When the kind of the thermoplastic resin is changed to decrease the hardness of the conductive polymer composition so that the problem of the generation of the defective image in the low-temperature environment is solved, the processability of the conductive polymer composition is liable to deteriorate. Thus it is difficult to improve the generation of the defective image in the low-temperature environment. In this respect, the conductive polymer composition composing the conductive roller leaves improvement for keeping the hardness thereof low in the low-temperature environment.

Patent document 1: Japanese Patent Application Laid-Open No. 2004-51829

Patent document 2: Japanese Patent Application Laid-Open No. 2004-269854

### SUMMARY OF THE INVENTION

The present invention has been made in view of the above-described problems. Therefore it is an object of the present invention to provide a conductive thermoplastic elastomer composition which has rubber-like elasticity and flexibility, resin-like favorable moldability, can be favorably recycled, can be adjusted widely in the electric resistance value thereof from a low electric resistance value, has a small change in the electric resistance value thereof when a voltage is applied thereto continuously, and is capable of securely keeping the quality thereof.

It is another object of the present invention to provide a conductive roller, formed from the conductive thermoplastic elastomer composition, which is capable of keeping a low hardness in a low-temperature environment and forming preferable images without causing defective transfer, defective charge, and defective transport.

To achieve the object, the first invention provides a method for producing a conductive thermoplastic elastomer composition including the steps of dynamically crosslinking a rubber component (B) containing at least one of diene rubber and ethylene-propylene-diene rubber separately from an ethylene oxide-propylene oxide-allyl glycidyl ether copolymer (C) containing an ionic-conductive salt in a composition (A) which is a mixture of a thermoplastic elastomer and a thermoplastic resin; and dispersing the rubber component (B) separately from the component (C) in the composition (A).

The second invention provides a conductive thermoplastic elastomer composition including a continuous phase and first and second uncontinuous phases. The continuous phase and the first and second uncontinuous phases form a sea-island structure; and the first and second uncontinuous phases independently forming island structures. In this structure, the continuous phase contains a composition (A) which is a mixture of a thermoplastic elastomer and a thermoplastic resin; the first continuous phase contains a rubber component (B) containing at least one of diene rubber and ethylene-propylene-diene rubber; and the second continuous phase contains an ethylene oxide-propylene oxide-allyl glycidyl ether copolymer containing an anion-containing salt having a fluoro group and a sulfonyl group (component (C)).

It is preferable to produce the conductive thermoplastic elastomer composition of the present invention by using the producing method of the first invention, but the method of producing the conductive thermoplastic elastomer composition is not limited thereto, but any methods can be used, provided that they have the above-described structure.

In the conductive thermoplastic elastomer composition of the present invention, the continuous phase is composed mainly of the composition (A). But the composition (A) may contain known additives. More specifically, the mass ratio of the composition (A) is 50 mass %, favorably not less than 75 mass %, more favorably not less than 90 mass %, and most favorably not less than 95 mass % of the entire mass of the continuous phase. Similarly, the first uncontinuous phase and the second uncontinuous phase are composed mainly of the rubber component (B) and the component (C) respectively. That is, the mass ratio of the rubber component (B) is not less than 50 mass %, favorably not less than 75 mass %, more favorably not less than 90 mass %, and most favorably not less than 95 mass % of the entire mass of the first uncontinuous phase. The mass ratio of the component (C) is not less than 50 mass %, favorably not less than 75 mass %, more favorably not less than 90 mass %, and most favorably not less than 95 mass % of the entire mass of the second uncontinuous phase.

In the conductive thermoplastic elastomer composition of the present invention, the ionic-conductive salt serving as a conductive material dissociates in the EO-PO-AGE copolymer and moves inside the second uncontinuous phase. Thereby the conductivity of the conductive thermoplastic elastomer composition is generated.

When the EO-PO-AGE copolymer is not dynamically crosslinked, the second uncontinuous phase is not present, and the component (C) is mixed with the continuous phase. As a result, when the ionic-conductive salt serving as the conductive material dissociates, the component (C) moves inside the continuous phase. Therefore a conductive path serves as the continuous phase, and there is a great change in the electric resistance value of the conductive thermoplastic elastomer composition in a continuous application of a voltage thereto.

When the EO-PO-AGE copolymer and the rubber component (B) containing at least one of the diene rubber and the EPDM rubber are simultaneously dynamically crosslinked, the second uncontinuous phase is not present, and the component (C) is mixed with the first uncontinuous phase. As a result, the moveability of ions generated by the dissociation of the ionic-conductive salt serving as the conductive material deteriorates. Thereby the conductive thermoplastic elastomer composition has a high electric resistance value. In addition, because the EO-PO-AGE copolymer interrupts the crosslinking of the rubber component, the rubber component is crosslinked at a low crosslinking degree. Thereby the conductive thermoplastic elastomer composition has a low compression set and is molded into the conductive roller or the like at a low moldability. When a large amount of the EO-PO-AGE copolymer is used to decrease the electric resistance value of the conductive thermoplastic elastomer composition, a wide conductive path is formed. As a result, when a voltage is continuously applied thereto, the conductive thermoplastic elastomer composition has a great change in the electric resistance value thereof and is produced at a high cost.

From the foregoing description, it is important that in the island structures displayed by the conductive thermoplastic elastomer composition of the present invention, the second uncontinuous phase containing the EO-PO-AGE copolymer having the ionic-conductive salt (C) forms independent island structures in the continuous phase.

It is favorable that the ionic-conductive salt is locally present in the second uncontinuous phase formed by dynamically crosslinking the EO-PO-AGE copolymer and more favorable that the ionic-conductive salt is little contained in the continuous phase and the first uncontinuous phase.

As will be described later, it is preferable to use the anion-containing salt having the fluoro group and the sulfonyl group as the ionic-conductive salt.

The mixing ratio among the components (A), (B), and (C) of the conductive thermoplastic elastomer composition of the present invention is appropriately selected according to the kind of compounds to be used, intended property and use of the conductive thermoplastic elastomer composition. It is especially preferable to mix the components (A), (B), and (C) with one another at the following ratio:

It is preferable to use 2 to 150 parts by mass of the component (A) which is the mixture of the thermoplastic elastomer and the thermoplastic resin for 100 parts by mass of the rubber component (B). When the mixing ratio of the composition (A) is less than two parts by mass, the amount of the resin component is so small that it is impossible to disperse the rubber component in the component (A) and difficult to process the conductive thermoplastic elastomer composition into the conductive roller or the like. In addition, products such as the conductive roller have a low strength, and the obtained composition is not thermoplastic and thus cannot be recycled. On the other hand, when the mixing ratio of the component (A) is more than 150 parts by mass, the amount of the resin component is so large that the conductive thermoplastic elastomer composition has a high hardness. Thus when the conductive thermoplastic elastomer composition is processed into the conductive roller to use it as a transfer roller, the area of contact between it and paper is small. Thus there is a possibility that the problem of defective transfer and defective transport occurs.

It is preferable that the mixing amount of the ionic-conductive salt for 100 parts by mass of the EO-PO-AGE copolymer is 0.5 to 20 parts by mass. When the mixing amount of the ionic-conductive salt is less than 0.5 parts by mass, the conductive thermoplastic elastomer composition is not sufficiently conductive. On the other hand, even though the mixing amount of the ionic-conductive salt is more than a certain level, the conductivity of the conductive thermoplastic elastomer composition little changes. Thus when the mixing ratio of the ionic-conductive salt is more than 20 parts by mass, the extent of the disadvantage of an increase in the cost of the conductive thermoplastic elastomer composition is great in comparison to the extent of the effect of improving the conductivity thereof.

Regarding the quantitative relationship between the component (C) and the composition (A) as well as the rubber component (B), it is favorable to adjust the mixing amount of the EO-PO-AGE copolymer to 1 to 40 parts by mass for 100 parts by mass of the rubber component (B). When the mixing amount of the EO-PO-AGE copolymer is less than one part by mass, the conductive thermoplastic elastomer composition is incapable of obtaining a sufficient conductive performance. On the other hand, when the mixing amount of the EO-PO-AGE copolymer is more than 40 parts by mass, the processability of the conductive thermoplastic elastomer composition is low and the production cost becomes high.

It is more favorable to set the mixing amount of the EO-PO-AGE copolymer to 1 to 30 parts by mass for 100 parts by mass of the rubber component (B).

The conductive thermoplastic elastomer composition of the present invention can be preferably produced by the producing method of the first invention, but is not limited thereto.

That is, in the producing method of the first invention, the rubber component (B) containing at least one of the diene rubber and the ethylene-propylene-diene rubber is dynamically crosslinked separately from the ethylene oxide-propylene oxide-allyl glycidyl ether copolymer containing the ionic-conductive salt (C) in the composition (A) which is the mixture of the thermoplastic elastomer and the thermoplastic resin; and the rubber component (B) is dispersed separately from the component (C) in the composition (A).

More specifically, it is preferable that the composition (A), the rubber component (B), and a crosslinking agent are mixed one another to dynamically crosslink the rubber component (B) with the crosslinking agent and disperse the rubber component (B) in the composition (A) to form an elastomer composition (I) and that the obtained elastomer composition (I), the component (C), and the crosslinking agent are mixed with one another to dynamically crosslink the component (C) with the crosslinking agent and disperse the component (C) in the composition W.

The first uncontinuous phase and the second uncontinuous phase can be independently formed by using the above-described producing method. In using this method, it is preferable to so adjust the mixing amount of the component (C) at subsequent steps that the mixing amount of the EO-PO-AGE copolymer is 1 to 40 parts by mass and that of the ionic-conductive salt is 0.01 to 10 parts by mass in 100 parts by mass of the elastomer composition (I).

Regarding the component (C), the EO-PO-AGE copolymer and the ionic-conductive salt may be mixed with each other in advance or the EO-PO-AGE copolymer and the ionic-conductive salt may be separately added to the elastomer composition (I) at a mixing step.

It is possible to mix the composition (A), the component (C), and the crosslinking agent with one another to form an elastomer composition composed of the composition (A) and the component (C) dispersed in the composition (A), and mix the obtained elastomer composition, the rubber component (B), and the crosslinking agent with one another to disperse the rubber component (B) in the component W.

It is also possible to mix the composition (A), the rubber component (B), and the crosslinking agent with one another to form an elastomer composition composed of the composition (A) and the component (B) dispersed in the composition (A) and mix the composition (A), the component (C), and the crosslinking agent with one another to form an elastomer composition composed of the composition (A) and the component (C) dispersed in the composition (A). Thereafter the obtained elastomer compositions are mixed with each other.

It is preferable that the heating temperature at which the rubber component (B) and the component (C) are dynamically crosslinked is set to 160 to 250° C. and that the heating period of time is 1 to 20 minutes. It is preferable that the heating temperature at which the components are mixed with one another is set to 160 to 250° C. and that the heating period of time is 1 to 20 minutes. A twin screw extruder, a Banbury mixer, a kneader or the like is used for the dynamic crosslinking and the mixing of the components.

The dynamic crosslinking crosslinkable may be performed in the presence of halogen, namely, chlorine, bromine, fluorine or iodine. To allow the halogen to be present at a dynamic crosslinking time, it is favorable to use a halogenated resin crosslinking agent or a halogen-donating substance. As the halogen-donating substance, tin chloride such as stannic chloride, ferric oxide, and cupric chloride are used. The halogen-donating substance can be used singly or in combination of two or more kinds thereof.

It is preferable to pelletize the conductive thermoplastic elastomer composition obtained by carrying out the above-described method to facilitate processing to be performed at subsequent steps. Thereby it is possible to obtain a preferable moldability.

The conductive thermoplastic elastomer composition of the present invention can be molded into a desired configuration by using known molding methods. It is preferable to mold the conductive thermoplastic elastomer composition into the shape of a roller because this configuration is widely applicable.

The conductive roller of the present invention composed of the conductive thermoplastic elastomer composition of the present invention can be produced by tubularly extruding the conductive thermoplastic elastomer composition by using an extruder and thereafter cutting the tubularly extruded conductive thermoplastic elastomer composition. It is also possible to produce the conductive roller by tabularly molding a pellet of the conductive thermoplastic elastomer composition by using an injection molder, polishing the surface of the molded tubular conductive thermoplastic elastomer composition, and cutting it to a required dimension.

In the present invention, an extrusion molding method can be preferably used because the extrusion molding method is capable of continuously producing tubes, does not require a polishing step, and is capable of considerably improving the productivity.

The third invention provides a method for producing a conductive roller formed by mixing micro-capsules each containing an acrylic group-containing polymer as an outer shell thereof with the conductive thermoplastic elastomer composition to form a mixture of the micro-capsules and the conductive thermoplastic elastomer composition; and extruding the mixture.

The fourth invention provides a conductive roller composed of a mixture of the conductive thermoplastic elastomer composition of the second invention and micro-capsules, each containing the acrylic group-containing polymer as the outer shell thereof. Although it is preferable to produce the conductive roller of the fourth invention by the producing method of the third invention, other producing methods can be used, provided that the conductive roller produced by other methods has the above-described construction.

By mixing the micro-capsules with the conductive thermoplastic elastomer composition, it is possible to keep the hardness of the conductive thermoplastic elastomer composition low in the low-temperature environment and greatly lower the conductivity thereof, even though the mixing amount of the ionic-conductive salt is small.

It is preferable to mix 0.5 to 5.0 parts by mass of the micro-capsules with 100 parts by mass of the conductive thermoplastic elastomer composition. When the mixing amount of the micro-capsules is less than 0.5 parts by mass, the micro-capsules hardly contribute to a decrease in the hardness of the conductive thermoplastic elastomer composition in a low-temperature environment and in addition, has a very low effect of decreasing the conductivity thereof, when the micro-capsules are used in combination with the salt. On the other hand, when the mixing amount of the micro-capsules is more than 5.0 parts by mass, the micro-capsules occupy a large volume in the conductive thermoplastic elastomer composition composing the conductive roller of the present invention. Thereby there is a possibility that the processability and strength of the conductive thermoplastic elastomer composition deteriorate.

The mixing amount of the micro-capsules for 100 parts by mass of the conductive thermoplastic elastomer composition is set to more favorably 1.0 to 4.0 parts by mass and especially favorably 1.0 to 3.5 parts by mass.

It is preferable that the extrusion temperature at the time of the extrusion molding is set to 150° C. to 210° C. when the micro-capsules are mixed with the conductive thermoplastic elastomer composition.

If the extrusion temperature at the time of the extrusion molding is less than 150° C., it is difficult to obtain a smooth rubber surface and irregularities are formed on the surface of the obtained conductive roller. If the extrusion temperature at the time of the extrusion molding is more than 210° C., the conductive thermoplastic elastomer deteriorates by heat. Thereby a trouble that a tube is cut during an extrusion operation occurs and it is difficult to perform continuous extrusion molding.

It is preferable that the conductive roller of the present invention has a cylindrical conductive layer consisting of the conductive thermoplastic elastomer composition and a columnar shaft. The construction of the conductive roller having one conductive layer on the periphery of the shaft is simple and preferable from the viewpoint of an industrial production. But other than the conductive layer, it is preferable to form a two-layer or three-layer construction to adjust the electric resistance value of the conductive roller and appropriately set the kind of each layer, the layering order, and the thickness of each layer according to performance demanded for the conductive roller. It is especially preferable to compose the outermost layer of the conductive layer.

It is possible to form an oxide film on the surface of the conductive roller by irradiating the surface thereof with ultraviolet rays. The oxide film serving as a dielectric layer decreases the loss tangent of the conductive roller. The oxide film serving as a low-friction layer provides a favorable toner separation effect.

A coating layer may be formed on the surface of the conductive member. For example, the coating layer can be formed by applying a known coating material which contains a main polymer consisting of urethane, acrylic resin or rubber latex and fluororesin dispersed in the main polymer to the surface thereof by using a known method such as electrostatic deposition, spray coating, dipping or brush paint. It is preferable that the thickness of the coating layer is set to 1 to 20 μm. By coating the surface of the conductive member with the coating material, it is possible to obtain the effect of easily scraping toner which remains on the surface thereof at a transfer time, changing attaching property of the toner to the surface thereof and the removing property of the toner from the surface thereof, controlling the surface energy, preventing attaching of paper powder and sticking of the toner to the surface thereof, and decreasing the coefficient of friction of the surface thereof.

The conductive roller of the present invention keeps the characteristic of the conductive thermoplastic elastomer composition. The electric resistance value of the conductive roller is adjustable in a wide range from a low electric resistance value and changes in a small range when a voltage is continuously applied thereto. Thus the conductive roller is capable of reliably holding its quality. It is preferable that as an index of the electric resistance value of the conductive roller of the present invention, it has 10⁶ to 10¹¹Ω in its initial electric resistance value when a voltage of 1000V is applied thereto and not more than three in its electric resistance ratio after the voltage of 1000V is continuously applied thereto for 24 hours. The initial electric resistance value of the conductive roller and the electric resistance ratio thereof after the voltage is continuously applied thereto for 24 hours are measured by a method described in the examples of the present invention which will be described later.

The conductive thermoplastic elastomer composition of the present invention is applicable to various uses demanding conductivity. The conductive thermoplastic elastomer composition can be preferably used as a conductive member of an image-forming apparatuses such as a printer, an electrostatic copying machine, a facsimile, an ATM, and the like. More specifically, the conductive roller composed of the conductive thermoplastic elastomer composition can be used as a charging roller for uniformly charging a photosensitive drum, a developing roller for attaching toner to the photosensitive member, a transfer roller for transferring a toner image to paper or an intermediate transfer belt from the photosensitive member, a toner supply roller for transporting the toner, a driving roller for driving a transfer belt from the inner side thereof, a paper-feeding roller (more specifically, paper supply roller, transport roller or paper discharge roller constructing paper supply mechanism) contributing to the transport of the paper, and a cleaning roller for removing residual toner. It is preferable to use the conductive roller of the present invention as the transfer roller.

The components contained in the conductive thermoplastic elastomer composition of the present invention are described in detail below.

It is desirable that the composition (A) which is the mixture of the thermoplastic elastomer and the thermoplastic resin remains an elastomer after the thermoplastic elastomer and the thermoplastic resin are mixed with each other. Thereby the obtained conductive thermoplastic elastomer composition of the present invention has a low hardness.

The mixing ratio between the thermoplastic elastomer of the composition (A) and the thermoplastic resin thereof can be determined according to the kind of an elastomer and that of a resin to be used. It is favorable to set the mixing amount of the thermoplastic resin for 100 parts by mass of the thermoplastic elastomer to not less than 1 nor more than 100 parts by mass. When the mixing amount of the thermoplastic resin is less than one part by mass, it is impossible to obtain the effect of mixing the thermoplastic resin with the thermoplastic elastomer. When the mixing amount of the thermoplastic resin is more than 100 parts by mass, the mixture of the thermoplastic elastomer and the thermoplastic resin is not an elastomer. It is more favorable to set the mixing amount of the thermoplastic resin for 100 parts by mass of the thermoplastic elastomer to not less than 20 nor more than 80 parts by mass.

Known thermoplastic elastomers can be used as the thermoplastic elastomer of the present invention.

More specifically, styrene elastomer, chlorinated polyethylene, vinyl chloride-based elastomer, olefin-based elastomer, urethane-based elastomer, ester-based elastomer, and amide-based elastomer are listed.

Of the thermoplastic elastomers, it is preferable to use the styrene elastomer.

As the styrene elastomer, it is possible to exemplify a copolymer block composed of a polymer block containing a styrene monomer as its main component and a block containing a conjugated diene compound as its main component and a hydrogenated conjugated diene polymer unit of the block copolymer. As the styrene monomer, it is possible to list styrene, α-methylstyrene, vinyl toluene, and t-butylstyrene. These styrene monomers can be used singly or in combination of not less than two kinds thereof. It is especially preferable to use the styrene as the styrene monomer. As the conjugated diene compound, it is possible to list butadiene, isoprene, chloroprene, and 2,3-dimethylbutadiene. These conjugated diene compounds may be used singly or in combination of not less than two kinds thereof.

As the styrene elastomers, it is possible to list a styrene-butadiene-styrene copolymer (SBS), a styrene-isoprene-styrene copolymer (SIS), a styrene-ethylene/butylene-styrene copolymer (SEBS), a styrene-ethylene/propylene-styrene copolymer (SEPS), and a styrene-ethylene-ethylene/propylene-styrene copolymer (SEEPS).

Of the styrene elastomers, it is favorable to use hydrogenated styrene thermoplastic elastomer and especially favorable to use the styrene-ethylene-ethylene/propylene-styrene copolymer (SEEPS).

As the thermoplastic resin, it is possible to use known thermoplastic resins. For example, olefin resin, polystyrene (PS), polyethylene terephthalate (PET), polybutylene terephthalate (PBT), and nylon are exemplified. It is especially preferable to the olefin resin. As the olefin resin, it is possible to list polyethylene, polypropylene, ethylene ethyl acrylate resin, ethylene vinyl acetate resin, ethylene-methacrylate resin, and ionomer resin. Of these olefin resins, it is favorable to use the polypropylene or the polyethylene. It is more favorable to use the polypropylene.

The rubber component (B) contains the diene rubber or/and the ethylene-propylene-diene rubber (EPDM rubber).

As the diene rubber, natural rubber (NR), butyl rubber (IIR), isoprene rubber (IR), butadiene rubber (BR), styrene-butadiene rubber (SBR), chloroprene rubber (CR), acrylonitrile-butadiene rubber (NBR), and 1,2-polybutadiene are listed. These rubbers can be used singly or as a mixture of two or more kinds of these rubbers.

The EPDM rubber includes the oil-unextended type consisting of a rubber component and the oil-extended type containing the rubber component and extended oil. Both types can be used in the present invention. As examples of diene monomers of the EPDM rubber, dicyclopentadiene, methylene norbornene, ethylidene norbornene, 1,4-hexadiene, and cyclooctadiene are listed.

The rubber component may contain rubber other than the diene rubber and the EPDM rubber. As the other rubbers, ethylene propylene rubber, acrylic rubber, and chlorosulfonated polyethylene are listed.

It is preferable that the conductive thermoplastic elastomer composition essentially contains the EPDM rubber as the rubber component thereof. The ratio of the EPDM rubber to the entire rubber component is set to favorably not less than 50 mass %, more favorably not less than 80 mass %, and most favorably 95 to 100 mass %. The main chain of the EPDM rubber consists of saturated hydrocarbon and does not contain double bonds. Thus even though the EPDM rubber is exposed to a high-concentration ozone atmosphere or irradiated with light for a long time, the molecular main chain thereof is hardly cut off. Therefore the EPDM rubber is capable of enhancing the weatherability of the conductive thermoplastic elastomer composition of the present invention.

The ratio of the ethylene oxide to the entire EO-PO-AGE copolymer of the component C is favorably not less than 55 mol % nor more than 95 mol % and more favorably not less than 65 mol % nor more than 95 mol %.

Cations derived from the salt are stabilized by the ethylene oxide unit and the propylene oxide unit. The ethylene oxide unit has a higher stabilizing performance than the propylene oxide unit in stabilizing the cations. Thus by setting the content ratio of the ethylene oxide unit higher than that of the propylene oxide unit, a large number of ions can be stabilized. If the content ratio of the ethylene oxide unit is more 95 mol %, the ethylene oxide unit crystallizes.

In the EO-PO-AGE copolymer, it is preferable to set the copolymerization ratio of the allyl glycidyl ether to not less than 1 mol % nor more than 10 mol %. If the copolymerization ratio of the allyl glycidyl ether is less than 1 mol %, bleeding is liable to occur and a photosensitive member is liable to be polluted. On the other hand, if the copolymerization ratio thereof is more than 10 mol %, the tensile strength, fatigue property, and bending resistance of the obtained composition are liable to deteriorate.

The number-average molecular weight of the EO-PO-AGE copolymer is favorably not less than 10000 and more favorably not less than 30000 to prevent bleeding and blooming from occurring and the photosensitive member from being polluted.

As the ionic-conductive salt to be added to the EO-PO-AGE copolymer, it is possible to use a salt capable of dissociating to anions and cations. It is preferable to use the anion-containing salt having the fluoro group and the sulfonyl group as the ionic-conductive salt.

As the anion-containing salt having the fluoro group and the sulfonyl group, it is preferable to use a salt having at least one kind of anion selected from among chemical formulas 1, 2, and 3 shown below.

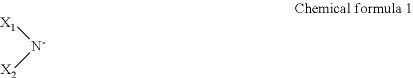

where X₁ and X₂ may be identical to each other or different from each other and show functional groups each containing one to eight carbon atoms, fluorine atoms, and a sulfonyl group (—SO₂—).

X₃-0⁻ Chemical formula 2

where X₃ shows functional group containing one to eight carbon atoms, fluorine atoms, and a sulfonyl group (—SO₂—).
Chemical formula 3

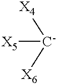

where X₄, X₅, and X₆ may be identical to each other or different from each other and show functional groups containing one to eight carbon atoms, fluorine atoms, and a sulfonyl group (—SO₂—).

The electric charge of the anion-containing salt is not locally present by a strong electron attraction effect of the fluoro group (—F) and the sulfonyl group (—SO₂—). Thus anions are stabilized and show a high dissociation degree in the conductive thermoplastic elastomer composition. Thereby a high ionic conductivity can be realized. Therefore owing to the addition of a small amount of the anion-containing salt to the EO-PO-AGE copolymer, it is possible to greatly reduce the electric resistance value of the conductive thermoplastic elastomer composition without greatly reducing values indicating various properties thereof. Further unlike carbon black, the anion-containing salt does not make the conductive thermoplastic elastomer change into black when it is added thereto. Thus the anion-containing salt is applicable to uses which require transparency and coloring.

The number of carbon atoms of the functional groups shown by X₁ through X₆ of the chemical formulas 1, 2, and 3 is one to eight, but favorably one to four and more favorably one to two to obtain a higher dissociation degree.

As the functional groups X₁ through X₆, a group shown by R—SO₂— (R shows hydrocarbon group, having 1 to 8 carbon atoms, which is substituted with fluorine atom) is exemplified.

As the hydrocarbon group having 1 to 8 carbon atoms, it is possible to list alkyl group such as methyl group, ethyl group, n-propyl group, isopropyl group, n-butyl group, isobutyl group, tert-butyl group, n-pentyl group, isopentyl group, tert-pentyl group, n-hexyl group, and 1,1-dimethylpropyl group; alkenyl group such as vinyl group, allyl group, 1-propenyl group, isopropenyl group, 2-butenyl group, 1,3-butadienyl group, and 2-pentenyl group; and alkynyl group such as ethynyl group, 2-propynyl group, 1-butynyl group, and 2-butynyl group. The number of fluorine atoms serving as a substituting group and the substituting position thereof are not specifically limited, provided that they fall in the range chemically permitted.

It is preferable that the functional groups X₁ through X₆ have a structure shown by CₙHₘF₍₂ₙ₋ₘ₊₁₎—SO₂— (n shows integers not less than one nor more than eight, and m shows integers not less than 0 nor more than 16).

It is preferable that a cation which makes a pair with an anion having the fluoro group and the sulfonyl group to form a salt is a cation of the alkali metals, the group 2A metals, the transition metals, or the amphoteric metals. The alkali metals are more favorable than the other metals in that the alkali metals have small ionization energy and are capable of readily forming stable cations. Of the alkali metals, a lithium ion having a high conductivity is especially preferable.

In addition to the metal cations, cations shown by the following chemical formulas 4 and 5 can be used.

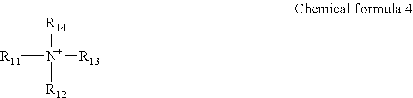

where R₁₁-R₁₄ show alkyl groups which have 1 to 20 carbon atoms, may have substituting group, and may be identical to each other or different from each other.

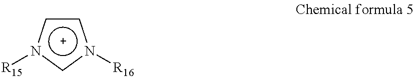

where R₁₅ and R₁₆ show alkyl groups which have 1 to 20 carbon atoms, may have substituting group, and may be identical to each other or different from each other.

As the “alkyl group which has 1 to 20 carbon atoms and may have substituting groups” shown by R₁₁-R₁₆, methyl, ethyl, n-propyl, i-propyl, n-butyl, i-butyl, t-butyl, n-pentyl, n-hexyl, and n-decyl are listed.

As the substituting groups, it is possible to list halogen (preferably fluorine, chlorine, bromine), oxo group, alkylene oxide group, alkanoyl group (preferably C₁₋₈), oxy alkanoyl group (preferably C₁₋₈), alkanoyl amino group (preferably C₁₋₈), carboxyl group, alkoxycarbonyl group (preferably C₂₋₈), haloalkyl carbonyl group (preferably C₂₋₈), alkoxy group (preferably C₁₋₈), halo alkoxy group (preferably C₁₋₈), amino group, alkylamino group (preferably C₁₋₈), dialkylamino group (preferably C₂₋₁₆), cyclic amino group, alkylamino carbonyl group (preferably C₂₋₈), carbamoyl group, hydroxyl group, nitro group, cyano group, mercapto group, alkylthio group (preferably C₁₋₈), oxy alkylsulfonyl group (preferably C₁₋₈), amino alkylsulfonyl group (preferably C₁₋₈), and phenyl group.

As the cation shown in the chemical formula 4, a trimethyl-type quaternary ammonium cation in which three of R₁₁ through R₁₄ are methyl group and one of R₁₁ through R₁₄ other than the three methyl groups is alkyl group which has 4 to 20 carbon atoms and may have a substituting group is especially preferable. The trimethyl-type quaternary ammonium cation is capable of stabilizing the positive electric charge of the nitrogen atom by the three methyl groups having a strong electron-donating property and in addition capable of improving compatibility with other components of the conductive thermoplastic elastomer composition by the alkyl group which has 4 to 20 carbon atoms and may have the substituting group.

On the cation shown in the chemical formula 5, the higher the electron-donating performance of R₁₅ or R₁₆ is, the higher the positive electric charge of the nitrogen atom can be stabilized. Thereby the cation shown by the chemical formula 5 has a higher stability and a higher dissociation degree to form the salt superior in conductivity-imparting performance. Therefore the alkyl group R₁₅ or R₁₆ is favorably an electron-donating group and more favorably the methyl group or the ethyl group.

As the anion-containing salt having the fluoro group and the sulfonyl group, bis(trifluoromethanesulfonyl)imide lithium ((CF₃SO₂)₂NLi), bis(trifluoromethanesulfonyl)imide potassium ((CF₃SO₂)₂NK), and lithium trifluorosulfonate (CF₃SO₃Li) are preferable. These salts are very stable at high temperatures. Therefore different from the perchlorate conventionally used, it is unnecessary to take an explosion-proof measure for these salts. Further these salts little deteriorate other properties of the conductive thermoplastic elastomer composition and are excellent in decreasing the electric resistance thereof at low temperature and low humidity. In this respect, these salts are superior in that by using them, it is possible to reduce the production cost and secure safety. Thus these salts have a high performance as the ionic-conductive agent.

In addition, the following salts are preferable as the anion-containing salt having the fluoro group and the sulfonyl group: (C₂F₅SO₂)₂NLi (C₄F₉SO₂) (CF₃SO₂)NLi, (FSO₂C₆F₄) (CF₃SO₂)NLi, (C₈F₁₇SO₂)(CF₃SO₂)NLi, (CF₃CH₂OSO₂)₂NLi, (CF₃CF₂CH₂OSO₂)₂NLi, (HCF₂CF₂CH₂OSO₂)₂NLi, ((CF₃)₂CHOSO₂)₂NLi, (CF₃SO₂)₃CLi, (CF₃CH₂OSO₂)₃CLi, C₄F₉SO₃Li, (C₂F₅SO₂)₂NK, (C₄F₉SO₂)(CF₃SO₂)NK, (FSO₂C₆F₄) (CF₃SO₂)NK, (C₈F₁₇SO₂)(CF₃SO₂)NK, (CF₃CH₂OSO₂)₂NK, (CF₃CF₂CH₂OSO₂)₂NK, (HCF₂CF₂CH₂OSO₂)₂NK, ((CF₃)₂CHOSO₂)₂NK, (CF₃SO₂)₃CK, (CF₃CH₂OSO₂)₃CK, and C₄F₉SO₃K.

As the anion-containing salt having the fluoro group and the sulfonyl group, the above-listed compounds can be used singly or in combination of two or more kinds thereof.

In the present invention, by single-ionizing a part of ions arising from the salt added to the EO-PO-AGE copolymer with an anion-adsorbing agent, it is possible to stabilize the electric conduction of the conductive thermoplastic elastomer composition and improve the electric conduction thereof when a small amount of the salt is added thereto.

As the anion-adsorbing agent, the following known compounds are useful: Synthesized hydrotalcite containing Mg and Al as its main component; a Mg—Al-containing inorganic ion exchanger, a Sb-containing inorganic ion exchanger, Ca-containing inorganic ion exchanger; and copolymers having ion seats for fixing anions to chains thereof.

For example, synthesized hydrotalcite (trade name: “Kyoward-2000”, “Kyoward-1000” produced by Kyowa Chemical Industry Co., Ltd.), anion-exchanging ion exchange resin (trade name: “Diaion DCA11” produced by Nippon Rensui Co.), and the like are listed.

A crosslinking agent is used for the conductive thermoplastic elastomer composition of the present invention to form the two uncontinuous phases.

As the crosslinking agent, known crosslinking agents such as a resin crosslinking agent or a peroxide can be used. It is favorable to use the resin crosslinking agent or the peroxide to dynamically crosslink the rubber component (B) and use the peroxide to dynamically crosslink the EO-PO-AGE copolymer of the component (C).

The resin crosslinking agent is a synthetic resin which allows the rubber component to make a crosslinking reaction by heating the rubber component. Compared with sulfur and a vulcanization accelerator which are used in combination, the resin crosslinking agent is preferable in that by the use of the resin crosslinking agent, the conductive thermoplastic elastomer composition hardly has blooming, has a low compression set, deteriorates to a low degree in the properties thereof, provides uniform accuracy, and is durable. Further the resin crosslinking agent allows the crosslinking period of time to be shorter than that required when a sulfur crosslinking agent is used. Thus the resin crosslinking agent allows the dynamic crosslinking to proceed in a short period of time in which the rubber component stays in an extruder.

As the resin crosslinking agents, phenolic resin, melamine.formaldehyde resin, triazine.formaldehyde condensate, and hexamethoxymethyl.melamine resin can be used. It is especially favorable to use the phenolic resin.

As examples of the phenolic resin, it is possible to use phenolic resins synthesized by reaction of phenols such as phenol, alkylphenol, cresol, xylenol or resorcin with aldehydes such as formaldehyde, acetic aldehyde, and furfural. It is possible to use halogenated phenolic resin in which at least one halogen atom is bonded to the aldehyde unit of the phenolic resin.

It is preferable to use alkylphenol-formaldehyde resin resulting from a reaction of the formaldehyde with the alkylphenol having alkyl group connected to the ortho position or the para position of benzene, because the alkylphenol.formaldehyde resin is compatible with rubber and reactive, thus making a crosslinking reaction start time comparatively early. The alkyl group of the alkylphenol.formaldehyde resin has 1-10 carbon atoms. Methyl group, ethyl group, propyl group, and butyl group are exemplified. Halides of the alkylphenol.formaldehyde resin can be preferably used.

As the resin crosslinking agent, it is possible to use modified alkylphenol resin formed by addition condensation of para-tertiary butyl phenol sulfide and aldehydes, and alkylphenol sulfide resin.

A crosslinking assistant may be used to accomplish the dynamic crosslinking reaction properly. Metal oxides are used as the crosslinking assistant. As the metal oxides, zinc oxide and zinc carbonate are especially preferable.

The mixing amount of the crosslinking assistant for 100 parts by mass of the rubber component is set to favorably not less than 0.5 to 10 parts by mass and more favorably not less than 0.5 to five parts by mass.

In the present invention, it is possible to use any peroxides capable of crosslinking the rubber component. For example, it is possible to list benzoyl peroxide, 1,1-bis(tert-butyl peroxy)-3,3,5-trimethylcyclohexane, 2,5-dimethyl-2,5-di-(benzoyl peroxy)hexane, di(tert-butyl peroxy)di-isopropylbenzene, 1,4-bis[(tert-butyl)peroxy isopropyl]benzene, di(tert-butyl peroxy)benzoate, tert-butyl peroxybenzoate, dicumyl peroxide, tert-butyl cumyl peroxide, 2,5-dimethyl-2,5-di (tert-butyl peroxy)hexane, di-tert-butyl peroxide, and 2,5-dimethyl-2,5-di(tert-butyl peroxy)-3-hexene. These peroxides may be used singly or by mixing two or more kinds thereof with each other.

A co-crosslinking agent may be used together with the peroxide. The co-crosslinking agent crosslinks itself and reacts with molecules of rubber and crosslinks them, thus making the entire rubber component polymeric. By co-crosslinking the rubber component with the co-crosslinking agent, it is possible to increase the molecular weight of crosslinked molecules and improve the wear resistance of the conductive thermoplastic elastomer composition.

As the co-crosslinking agent, it is possible to list polyfunctional monomers, metal salts of methacrylic acid or acrylic acid, methacrylic ester, aromatic vinyl compounds, heterocyclic_vinyl compounds, allyl compounds, polyfunctional polymers utilizing the functional group of 1,2-polybutadiene, and dioximes.

In adding the co-crosslinking agent to the rubber component together with the peroxide, the mixing amount of the co-crosslinking agent can be selected appropriately according to the kind thereof and the kind of other components to be used.

The mixing amount of the co-crosslinking agent is set to favorably not less than 5 nor more than 20 parts by mass and more favorably not less than 10 nor more than 15 parts by mass for 100 parts by mass of the rubber component.

The mixing amount of the crosslinking agent can be selected appropriately according to the kind of a compound to be crosslinked thereby and the kind thereof and cannot be said definitely.

When the resin crosslinking agent is used, the mixing amount thereof is set to favorably 2 to 20 parts by mass for 100 parts by mass of a compound to be crosslinked. If the mixing amount of the resin crosslinking agent is less than two parts by mass, crosslinking is insufficiently performed. Thus the conductive thermoplastic elastomer composition has a low wear resistance. On the other hand, if the mixing amount of the resin crosslinking agent is more than 20 parts by mass, there is a possibility that the conductive roller of the present invention composed of the composition has a very high hardness. It is more favorable that the mixing amount of the resin crosslinking agent is set to not less than five nor more than 15 parts by mass for 100 parts by mass of the compound to be crosslinked.

When the peroxide is used, it is favorable that the mixing amount thereof is set to 0.2 to 3.0 parts by mass for 100 parts by mass of a compound to be crosslinked. If the mixing amount of the peroxide is set to less than 0.2 parts by mass, the rubber component is insufficiently crosslinked. Thus the conductive thermoplastic elastomer composition has an inferior wear resistance. On the other hand, if the mixing amount of the peroxide exceeds 3.0 parts by mass, the property of the conductive thermoplastic elastomer composition deteriorates because molecules of the rubber component are cut off and in addition a defective dispersion occurs. Therefore the processability is difficult. The mixing amount of the peroxide is set to more favorably not less than 0.5 parts by mass and most favorably not less than 1.0 part by mass for 100 parts by mass of the compound to be crosslinked. The mixing amount of the peroxide is set to favorably not more than 2.5 parts by mass and especially favorably not more than 2.0 parts by mass for 100 parts by mass of the compound to be crosslinked.

The conductive thermoplastic elastomer composition of the present invention may contain other components so long as the use of other components is not contradictory to the object of the present invention. For example, the conductive thermoplastic elastomer composition may contain additives such as a filler, a softener, a compatibilizing agent, an age resistor, an antioxidant, an ultraviolet ray-absorbing agent, a lubricant, a pigment, an antistatic agent, a flame retardant, a neutralizer, a nucleating agent, and an agent for preventing the generation of air-bubbles.

The conductive thermoplastic elastomer composition may contain a filler and the like to improve the mechanical strength thereof. As the filler, it is possible to use powder of silica, carbon black, clay, talc, calcium carbonate, dibasic phosphite (DLP), basic magnesium carbonate, and alumina. It is preferable to use not more than 15 mass % of the filler for the entire mass of the conductive thermoplastic elastomer composition of the present invention. The above-described mixing range is set for the reason described below. The filler is effective for improving the tensile strength and tearing strength of the conductive thermoplastic elastomer composition. But if the filler is used in a very large amount, the flexibility thereof deteriorates. Consequently a roller composed of the conductive thermoplastic elastomer composition has a low coefficient of friction.

The conductive thermoplastic elastomer composition of the present invention may contain a softener to allow it to be appropriately flexible and elastic.

As the softener, oil and plasticizer can be used. As the oil, it is possible to use mineral oil such as paraffin oil, naphthenic oil, aromatic oil and known synthetic oil composed of hydrocarbon oligomer, and process oil. As the synthetic oil, it is possible to use oligomer of α-olefin, oligomer of butene, and amorphous oligomer of ethylene and α-olefin. It is possible to use plasticizers consisting of phthalates, adipates, sebacates, phosphates, polyethers, and polyesters. More specifically it is possible to list dioctyl phthalate (DOP), dibutyl phthalate (DBP), dioctyl sebacate (DOS), and dioctyl adipate (DOA).

As the softener, paraffin oil is favorable and paraffin process oil is more favorable.

The mixing amount of the softener is set to 50 to 250 parts by mass, favorably 50 to 200 parts by mass, and more favorably 70 to 150 parts by mass for 100 parts by mass of the rubber component (B).

If the mixing amount of the softener is less than the above-described lower limit value, it is difficult to obtain the effect of adding the softener to the component (B), namely, the effect of improving the dispersibility of the component (B) or that of the component (C) at a dynamic crosslinking time. In addition, the hardness of the conductive thermoplastic elastomer composition is liable to become high. On the other hand, if the mixing amount of the softener is more than the above-described upper limit value, the softener inhibits crosslinking. Consequently the dynamic crosslinking cannot be sufficiently accomplished and hence the conductive thermoplastic elastomer composition has deteriorated properties and in addition the softener is liable to bleed.

The above-described mixing amount of the softener includes the amount of extended oil when the extended oil is used as the rubber component.

It is preferable that the conductive thermoplastic elastomer composition of the present invention contains the compatibilizing agent. By so doing, it is possible to improve the dispersibility of the components of the conductive thermoplastic elastomer composition and especially the dispersibility of the salt and in addition improve the compatibility of the micro-capsules with the conductive thermoplastic elastomer composition, when the micro-capsules are mixed therewith.

It is preferable that the mixing amount of the compatibilizing agent is 1 to 20 parts by mass for 100 parts by mass of the rubber component (B). If the mixing amount of the compatibilizing agent is less than one part by mass, the effect of the compatibilizing agent is insufficiently displayed. Thus the elastomer composition (I) and the EO-PO-AGE copolymer do not favorably mix with each other. Thereby the conductive thermoplastic elastomer composition is nonuniform, which may cause a fear that the processability thereof deteriorates. If the mixing amount of the compatibilizing agent is less than one part by mass in mixing the micro-capsules with the conductive thermoplastic elastomer composition, the conductive thermoplastic elastomer composition and the expanded micro-capsules, namely, the micro-balloon cannot be favorably mixed with each other. Thereby the conductive thermoplastic elastomer composition is nonuniform and there is a fear that the processability thereof deteriorates. On the other hand, if the mixing amount of the compatibilizing agent is more than 20 parts by mass, the effect to be provided by the addition of the compatibilizing agent is utmost and is not improved any more, but the conductive thermoplastic elastomer composition has a high hardness.

It is preferable that the conductive dynamically crosslinked thermoplastic elastomer composition contains an ethylene-acrylic ester-glycidyl methacrylate copolymer or an ethylene-acrylic ester-maleic anhydride copolymer.

As the acrylic ester in the ethylene-acrylic ester-glycidyl methacrylate copolymer or the ethylene-acrylic ester-maleic anhydride copolymer, it is possible to list esterified substances produced by the reaction between alcohol and acrylic acid such as methyl acrylate, ethyl acrylate, propyl acrylate, butyl acrylate, 2-ethylhexyl acrylate. The methyl acrylate and the ethyl acrylate are favorable.

The content ratio of the acrylic ester to the above-described copolymer is set favorably to the range of 0.1 to 30 mass %, more favorably to the range of 1 to 20 mass %, and most favorably to the range of 5 to 15 mass %. The content ratio of the glycidyl methacrylate or the maleic anhydride to the copolymer is set to the range of 0.05 to 20 mass %, favorably in the range of 0.1 to 15 mass %, more favorably in the range of 0.5 to 10 mass %, and most favorably in the range of 1 to 10 mass %.

As compatibilizing agent, it is possible to use one or not less than two kinds of terpolymers corresponding to the definition described below, together with the above-described two kinds of copolymers.

The terpolymer serving as the compatibilizing agent is composed of an olefin component (c1), acrylic ester component (c2) or methacrylic ester component (c2), and an unsaturated carboxylic unit (c3).

As the olefin component (c1), it is possible to list ethylene hydrocarbons having 2 to 6 carbon atoms such as ethylene, propylene, isobutylene, 1-butene, 1-pentene, and 1-hexene.

As examples of the acrylic ester component (c2) or the methacrylic ester component (c2), it is possible to list esterified substances produced by a reaction between alcohol and acrylic acid or methacrylic acid such as methyl acrylate, methyl methacrylate, ethyl acrylate, ethyl methacrylate, propyl acrylate, propyl methacrylate, butyl acrylate, butyl methacrylate, 2-ethylhexyl acrylate, 2-ethylhexyl methacrylate. Of these acrylic esters or the methacrylic esters, the methyl acrylate, the methyl methacrylate, the ethyl acrylate, and the ethyl methacrylate are preferable.

The unsaturated carboxylic acid unit (c3) is introduced by unsaturated carboxylic acids or anhydrides thereof. More specifically, it is possible to list acrylic acid, methacrylic acid, maleic acid, maleic anhydride, itaconic acid, itaconic anhydride, fumaric acid, crotonic acid, half ester of unsaturated dicarboxylic acid, and half amide. Above all, the acrylic acid, the methacrylic acid, the maleic acid, and the maleic anhydride are favorable. The maleic anhydride is especially favorable. The form of the unsaturated carboxylic acid unit is not limited to a specific mode, provided that it is copolymerized with the above-described terpolymer. It is possible to exemplify a random copolymer, a block copolymer, and a graft copolymer.

The content of the acrylic ester component (c2) or the methacrylic ester component (c2) is set to favorably 0.1 to 30 mass %, more favorably 1 to 20 mass %, and most favorably 5 to 15 mass %. The content of the unsaturated carboxylic unit (c3) is set to 0.05 to 20 mass %, favorably 0.1 to 15 mass %, more favorably 0.5 to 10 mass %, and most favorably 1 to 10 mass %.

The micro-capsule of the present invention has the acrylic group-containing polymer as the outer shell thereof.

The amount of the acrylic group contained in each micro-capsule is not limited to a specific amount. Favorably not less than five parts by mass and more favorably not less than 10 parts by mass of a monomer necessary for generating the acrylic group is contained in 100 parts by mass of the polymer forming the outer shell of each micro-capsule.

As monomers, having a carboxylic group, which are necessary for generating the acrylic group, it is possible to list unsaturated monocarboxylic acids such as acrylic acid, methacrylic acid, ethacrylic acid, crotonic acid, and cinnamic acid; unsaturated dicarboxylic acids such as maleic acid, itaconic acid, fumaric acid; citraconic acid, and chloromaleic acid; monoesters of unsaturated dicarboxylic acids such as monomethyl maleate, monoethyl maleate, monobutyl maleate, monomethyl fumarate, monoethyl fumarate, monomethyl itaconate, monoethyl itaconate, monobutyl itaconate, and derivatives thereof. Above all, the acrylic acid, the methacrylic acid, the itaconic acid, styrene sulfonate, the maleic acid, the fumaric acid, and the citraconic acid are favorable. These monomers may be used in the form of salts or by mixing not less than two kinds thereof.

The micro-capsule which is used in the present invention is not restricted to a specific one, but known micro-capsules can be used, provided that they have the acrylic group-containing polymer as the outer shell thereof.

As the micro-capsule which can be used in the present invention, it is possible to exemplify micro-capsules in which a polymer forming the outer shell is composed of a nitrile monomer, a monomer having carboxylic group, a monomer having amide group, a monomer having an annular structure at its side chain, and a monomer (crosslinking agent) having not less than two polymerizable double bonds.

As the composing ratio of the monomers in the polymer, the polymer contains the nitrile monomer at favorably 15 to 75 mass % and more favorably 25 to 65 mass %, the monomer having the carboxylic group at favorably 10 to 65 mass % and more favorably 20 to 55 mass %, the monomer having the amide group at favorably 0.1 to 20 mass % and more favorably 1 to 10 mass %, the monomer having the annular structure at its side chain at favorably 0.1 to 20 mass % and more favorably 1 to 10 mass %, and the monomer (crosslinking agent) having not less than two polymerizable double bonds at favorably 0 to 3 mass %.

The polymer composing the outer shell of the micro-capsule having the above-described form may contain an inorganic substance. It is preferable that the content ratio of the inorganic substance is in the range of 1 to 25 mass %.

As the nitrile monomer, it is possible to list acrylonitrile, methacrylonitrile, α-chloroacrylonitrile, α-ethoxy acrylonitrile, fumaronitrile, and mixtures of monomers arbitrarily selected from among these nitrile monomers. The acrylonitrile and/or the methacrylonitrile are especially preferable.

As the monomer having the amide group, acrylamide, methacrylamide, and N,N-dimethylacrylamide, and N,N-dimethylmethacrylamide are listed.

As the monomer having the annular structure at its side chain, styrene, α-methylstyrene, chlorostyrene, isobornyl (metha) acrylate, and cyclohexyl methacrylate are listed. It is also possible to exemplify phenylmaleimide, cyclohexylmaleimide, and the like having the annular structure at its main chain and side chain as the monomer having the annular structure at its side chain.

As the monomer (crosslinking agent) having not less than two polymerizable double bonds, it is possible to list divinylbenzene, ethylene glycol di(metha)acrylate, diethylene glycol di(metha) acrylate, triethylene glycol di(metha)acrylate, PEG#200 di(metha)acrylate, PEG#400 di(metha)acrylate, PEG#600 di(metha)acrylate, triacrylic formal, trimethylolpropane trimethacrylate, allyl methacrylate, 1,3-butyl glycol dimethacrylate, and triallyl isocyanate.

In addition, it is possible to exemplify micro-capsules in which the polymer forming the outer shell is composed of the nitrile monomer, a monomer having unsaturated double bonds and carboxylic groups in its molecules, the monomer having not less than two polymerizable double bonds, and a monomer copolymerizable with these monomers to adjust the expansion characteristic of the micro-capsule.

As the composing ratio of the monomers of the polymer, the polymer contains the nitrile monomer at favorably 40 to 95 mass % and more favorably 50 to 90 mass %, the monomer having the unsaturated double bonds and the carboxylic groups at favorably 7 to 60 mass % and more favorably 10 to 50 mass %, the monomer having not less than two polymerizable double bonds at favorably 0.05 to 5 mass % and more favorably 0.2 to 3 mass %, and the monomer copolymerizable with these monomers to adjust the expansion characteristic of the polymer at favorably 0 to 20 mass % and more favorably 0 to 15 mass %.

As the nitrile monomer, the monomer having the unsaturated double bonds and the carboxylic groups in its molecule, and the monomer having not less than two polymerizable double bonds, the above-exemplified compounds are listed.

As the monomer copolymerizable with other monomers to adjust the expansion characteristic, it is possible to list (metha) acrylic ester such as vinylidene chloride, vinyl acetate, methyl(metha)acrylate, ethyl(metha)acrylate, n-butyl(metha)acrylate, isobutyl(metha)acrylate, t-butyl(metha)acrylate, isobornyl(metha)acrylate, cyclohexyl(metha)acrylate, benzyl(metha)acrylate, and β-carboxyethyl acrylate; styrene monomers such as styrene, styrene sulfonic acid and sodium salts thereof, α-methylstyrene, and chlorostyrene; monomers which progresses polymerization reaction by a free-radical initiator such as acrylamide, substituted acrylamide, methacrylamide, substituted methacrylamide and mixtures thereof. It is preferable that the polymer does not contain a monomer such as N-methylolacrylamide having a functional group which reacts with the carboxylic group.

In addition, it is possible to exemplify micro-capsules in which the polymer forming the outer shell is composed of the monomer containing the acrylonitrile and the carboxylic group, a monomer having a group which reacts with the carboxylic group of the above-described monomer containing the acrylonitrile and the carboxylic group, the monomer having not less than two polymerizable double bonds or/and a monomer, having a high Tg, which serves as a component for adjusting a softening temperature. The monomer having not less than two polymerizable double bonds and the monomer having a high Tg are used as desired.

As the composing ratio of the monomers of the polymer, the polymer contains acrylonitrile at favorably 20 to 80 mol % and more favorably 30 to 70 mol %; the monomer containing the carboxylic groups at favorably 5 to 40 mol % and more favorably 10 to 30 mol %; the monomer having the group which reacts with the carboxylic group at favorably 1 to 30 mol % and more favorably 2 to 20 mol %; and the monomer having not less than two polymerizable double bonds at favorably 0 to 5 mol % and more favorably 0 to 3 mol %; and the monomer having a high Tg at favorably 0 to 50 mol % and more favorably 10 to 40 mol %.

As the monomer having the carboxylic group and the monomer having not less than two polymerizable double bonds, the above-exemplified compounds are listed.

As the monomer having the group which reacts with the carboxyl group, it is possible to list N-methylolacrylamide, N-methylolmethacrylamide, glycidyl acrylate, glycidyl methacrylate, 2-hydroxyethyl (metha)acrylate, 2-hydroxypropyl (metha)acrylate, 2-hydroxybutyl (metha)acrylate, 2-hydroxy-3-phenoxypropyl acrylate, N,N-dimethylaminoethyl (metha)acrylate, N,N-dimethylaminopropyl methacrylate, magnesium monoacrylate, and zinc monoacrylate.

As the monomer having a high Tg, it is possible to list homopolymers having the Tg at not less than 80° C. Such monomers include methacrylonitrile, acrylamide, methacrylamide, N,N-dimethylacrylamide, N,N-dimethylmethacrylamide, methyl methacrylate, t-butyl methacrylate, isobornyl (metha)acrylate, cyclohexyl methacrylate, benzyl methacrylate, N-vinylpyrrolidone, and styrene.

In addition, it is possible to exemplify micro-capsules in which the polymer forming the outer shell thereof is composed of a copolymerized polymer resulting from copolymerization of the nitrile monomer and the monomer containing the carboxylic group; and monovalent through trivalent metal cations which crosslink ions of the copolymerized polymer.

As the composing ratio of the monomers of the polymer, the polymer contains the nitrile monomer at preferably less than 80 mass % to the entire monomers and the monomer containing the carboxylic group at preferably 5 to 50 mass % to the entire monomers. The ratio of the metal cations to 100 parts by mass of the monomer containing the carboxylic groups is preferably 0.1 to 10 parts by mass.

As the nitrile monomer and the monomer containing the carboxylic group, the above-exemplified compounds are listed. It is preferable that both nitrile monomer and the monomer containing the carboxylic group are radical polymerizable unsaturated monomers.

As the “monovalent through trivalent metal cations”, it is possible to list potassium cation, sodium cation, cesium cation, lithium cation, magnesium cation, calcium cation, barium cation, iron cation, nickel cation, copper cation, zinc cation, tin cation, chrome cation, lead cation, strontium cation, and aluminum cation.

The “monovalent through trivalent metal cations” are contained in the polymer in the form of metal cation supplier. As the metal cation supplier, it is possible to list hydroxides of the above-described “monovalent through trivalent metal cations”; and phosphate, carbonate, nitrate, sulfate, chloride, nitrite, sulfite, and salts of organic acids such as octyl acid, stearic acid, and the like. More specifically, it is possible to list hydroxides such as sodium hydroxide, potassium hydroxide, lithium hydroxide, zinc hydroxide, nickel hydroxide, iron hydroxide, copper hydroxide, magnesium hydroxide, aluminum hydroxide, calcium hydroxide, and barium hydroxide; chlorides such as sodium chloride, potassium chloride, lithium chloride, magnesium chloride, calcium chloride, barium chloride, zinc chloride, and aluminum chloride; and phosphates such as sodium phosphate, lithium phosphate, calcium phosphate, zinc phosphate, and aluminum phosphate; and carbonates such as potassium carbonate, sodium carbonate, lithium carbonate, calcium carbonate, and zinc carbonate. Above all, hydroxides of transition metals such as the zinc hydroxide, the nickel hydroxide, the iron hydroxide, and the copper hydroxide are favorable. Hydroxides of bivalent transition metals are more favorable.

The micro-capsule includes a thermally expansive type and an expanded type. Both types can be used in the present invention.

The outer shell of the thermally expansive micro-capsule envelopes a low boiling point substance (thermal expansion agent). When the thermally expansive micro-capsule is heated, the polymer of the outer shell softens and expands owing to vaporization of the low boiling point substance, thus becoming a micro-balloon (hollow spherical particle).

As the low boiling point substances contained in the outer shell, those which have boiling points not more than softening points of the thermoplastic resin composing the outer shell and become gaseous are preferable. As the low boiling point substance, it is possible to list low boiling point liquids such as propane, propylene, butene, normal butane, isobutane, isopentane, neopentane, normal pentane, hexane, heptane, petroleum ether, halides of methane, and tetraalkylsilane; and compounds such as AIBN which are thermally decomposed and become gaseous when they are heated. Of these low boiling point substances, low boiling point liquid hydrocarbons such as the isobutane, the normal butane, the normal pentane, and the isopentane can be preferably used. These low boiling point substances can be used singly or by combining not less than two kinds thereof.

The coefficient of thermal expansion of the thermally expansive micro-capsule is favorably not less than two times larger than the original volume thereof and more favorably in the range of 2 to 20 times larger than the original volume thereof.

The expansion start temperature of the thermally expansive micro-capsule is favorably not less than 100° C. and more favorably not less than 130° C. The maximum expansion temperature thereof is favorably not less than 130° C., more favorably not less than 160° C., and most favorably not less than 170° C. The upper limit value of the maximum expansion temperature thereof is not limited to a specific value, but normally about 250° C.

It is favorable that the particle diameter of the micro-capsule is not less than 100 μm.

If the particle diameter of the micro-capsule is less than 100 μm, it is necessary to add a large amount of micro-capsules to the conductive thermoplastic elastomer composition to decrease the hardness of the conductive thermoplastic elastomer composition, which is not preferable in the processability thereof in extrusion and cost thereof.

The upper limit of the particle diameter of the micro-capsule is not specifically limited. Even though the particle diameter of the micro-capsule is very large, it is possible to take a balance between the hardness of the conductive thermoplastic elastomer composition and the extrusion moldability thereof as well as the strength thereof by controlling the mixing amount of the micro-capsule. However, if the particle diameter of the micro-capsule is more than 500 μm, the micro-capsule occupies a large volume in the conductive thermoplastic elastomer composition constructing the conductive roller of the present invention. Thus there is a possibility that the processability of the conductive thermoplastic elastomer composition deteriorates and the strength thereof decreases. Therefore the particle diameter of the micro-capsule is favorably not more than 500 μm and more favorably not more than 300 μm.

The “particle diameter” of the thermally expansive micro-capsule means the particle diameter after it expands.

The Shore A hardness of the conductive roller of the present invention containing the micro-capsules is not more than 30 at 23° C., when the Shore A hardness is measured in accordance with JIS K 6253. If the Shore A hardness is more than 40, there is a possibility that a defective image is generated when the hardness of the conductive roller composed of the conductive thermoplastic elastomer composition is used at low temperatures not more than 15° C. Even though the Shore A hardness is more than 30 nor more than 40, there is a possibility that a defective image is generated, although the frequency of the generation of the defective image is low.

Although the lower limit value of the Shore A hardness is not specifically limited, it is preferable that the Shore A hardness is set to favorably not less than 10.

It is preferable that the micro-capsule which is used in the present invention has a high configuration-holding performance against a load applied thereto. More specifically, when a load of 15 MPa is applied to the micro-capsule, a volume-holding percentage after the load is applied thereto is favorably not less than 50%, more favorably not less than 70%, and most favorably not less than 80%. The volume-holding percentage of the thermally expansive micro-capsule is measured when it is thermally expanded.

The micro-capsule which is used in the present invention can be produced by using a known method and is commercially available. For example, it is possible to selectively use “EXPANCEL (commercial name)” produced by Akzo Nobel and “Matsumoto Microsphere (commercial name)” produced by Matsumoto Yushi-Seiyaku Co., Ltd.

It is especially preferable to use “Matsumoto Microsphere F-105 (commercial name)” (produced by Matsumoto Yushi-Seiyaku Co., Ltd.) having a particle diameter of not less than 100 μm.

The effect of the present invention is described below. In the conductive thermoplastic elastomer composition of the present invention, the EO-PO-AGE copolymer and the ionic-conductive salt are used in combination to make the conductive thermoplastic elastomer composition conductive. Therefore the electric resistance value of the conductive thermoplastic elastomer composition can be widely set from a low value and changes to a low extent when a voltage is continuously applied thereto. In addition, because a small amount of the salt is used, a high extrusion processability is obtained, and the production cost is low.

Further, because the EO-PO-AGE copolymer containing the ionic-conductive salt is dynamically crosslinked to form the uncontinuous phase, the conductive path is restricted. Consequently the change in the electric resistance value of the conductive thermoplastic elastomer composition is effectively suppressed to a low extent when a voltage is continuously applied to the conductive roller composed of the conductive thermoplastic elastomer composition.

In the conductive thermoplastic elastomer composition of the present invention, the rubber component (B) containing at least one of the diene rubber and the ethylene-propylene-diene rubber is dynamically crosslinked in the mixture (component A) of the thermoplastic elastomer and the thermoplastic resin. Therefore the conductive thermoplastic elastomer composition is provided with rubber-like durability, elasticity, and flexibility and resin-like moldability. Further the composition of the present invention is thermoplastic and can be recycled.

In addition, because the rubber component (component B) independently forms the uncontinuous phase, the crosslinking degree of the rubber is not affected by the component (C), although the component (C) is dispersed in the component (A). Consequently it is possible to suppress an increase of the compression set because the crosslinking degree does not become low and in addition the electric resistance of the conductive thermoplastic elastomer composition can be effectively decreased. Further the conductive thermoplastic elastomer composition has a proper degree of hardness, does not pollute a photosensitive member, and is capable of decreasing the variation of the electric resistance thereof.

The conductive roller produced by mixing micro-capsules each containing the acrylic group-containing polymer as its outer shell with the conductive thermoplastic elastomer composition and extruding the mixture is capable of keeping a low hardness even in a low-temperature environment. Therefore an image-forming apparatus where the conductive roller is mounted is capable of forming preferable images without causing defective transfer, defective charge, and defective transport at a low temperature. When the particle diameter of the micro-capsule is not less than 100 μm nor more than 500 μm, it is not necessary to sacrifice the processability to decrease the hardness of the conductive thermoplastic elastomer composition, but preferable moldability can be achieved.

### BRIEF DESCRIPTION OF THE DRAWINGS

FIG. 1 is an illustration microscopically showing a conductive thermoplastic elastomer composition of the present invention.

FIG. 2 is a schematic view showing a conductive roller of the present invention.

FIG. 3 is a schematic view showing a method of measuring the electric resistance value of the conductive roller shown in FIG. 2.

### DETAILED DESCRIPTION OF THE PREFERRED EMBODIMENTS

The embodiments of the present invention will be described below.

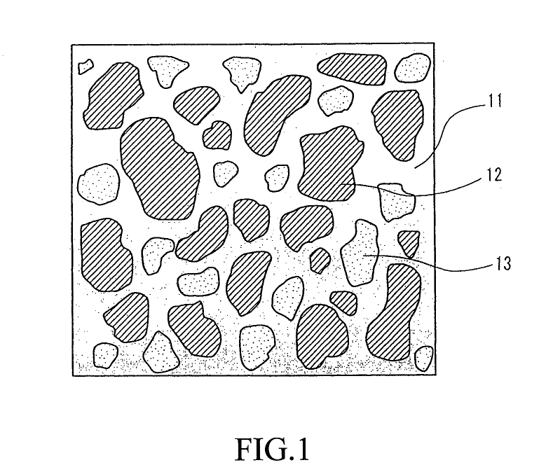

As shown in FIG. 1, in the conductive thermoplastic elastomer composition of a first embodiment of the present invention, microscopically, a continuous phase 11, a first uncontinuous phase 12, and a second uncontinuous phase 13 form a sea-island structure. The first uncontinuous phase 12 and the second uncontinuous phase 13 independently form island structures in the continuous phase 11.

The continuous phase 11 is composed of a composition (A) formed by mixing a styrene thermoplastic elastomer which is a thermoplastic elastomer and an olefin resin which is a thermoplastic resin with each other.

The first uncontinuous phase 12 is composed of an EPDM rubber composition (B) which is a rubber component.

The second uncontinuous phase 13 is composed of the component (C) comprising an EO-PO-AGE copolymer containing an anion-containing salt, having a fluoro group and a sulfonyl group, which is an ionic-conductive salt.

Each of the continuous phase 11, the first uncontinuous phase 12, and the second uncontinuous phase 13 may contain a crosslinking agent, a softener, a compatibilizing agent, and the like.

To form the component (A), polypropylene is used as the olefin resin, and a styrene-ethylene-ethylene/propylene-styrene copolymer (SEEPS) is used as the styrene thermoplastic elastomer. As the mixing ratio between the styrene thermoplastic elastomer and the olefin resin, 30 to 50 parts by mass of the olefin resin is mixed with 100 parts by mass of the styrene thermoplastic elastomer.

As the mixing ratio between the composition (A) and the EPDM rubber component (B), the former is contained at favorably 20 to 120 parts by mass, more favorably 40 to 100 parts by mass, and most favorably 50 to 90 parts by mass for 100 parts by mass of the latter.

In the EO-PO-AGE copolymer of the component (C), the content ratio among ethylene oxide:propylene oxide:allyl glycidyl ether is 80 to 95 mol %:1 to 10 mol %:1 to 10 mol %. It is especially favorable that the number-average molecular weight Mn of the EO-PO-AGE copolymer is not less than 50,000.

The mixing amount of the EO-PO-AGE copolymer for 100 parts by mass of the EPDM rubber which is the component (B) is set to favorably 5 to 30 parts by mass and more favorably 10 to 25 parts by mass.

As the anion-containing salt having the fluoro group and the sulfonyl group, a salt containing the anion shown by the above-described chemical formula 1 or 2 is favorable. The anion-containing salt having the functional group CF₃SO₂— shown by X₁-X₃ in the chemical formula 1 or 2 is more favorable. A cation which makes a pair with an anion to form a salt is favorably the alkali metal and more favorably a lithium ion. More specifically, as the salt, bis(trifluoromethanesulfonyl)imide lithium is especially favorable.

The mixing amount of the anion-containing salt having the fluoro group and the sulfonyl group for 100 parts by mass of the EO-PO-AGE copolymer is set to favorably 0.5 to 20 parts by mass and more favorably 5 to 15 parts by mass.

The method for producing the conductive thermoplastic elastomer composition having the above-described structure is described below.

Initially the EPDM rubber which is the component (B) is pelletized. The pelletized EPDM rubber, the styrene thermoplastic elastomer and the olefin resin (component (A)), the crosslinking agent, and the softener are kneaded at 200° C. to dynamically crosslink the EPDM rubber (component (B)) with the crosslinking agent so that the EPDM rubber is dispersed in the component (A) to form the elastomer composition (I).

The obtained elastomer composition (I), the EO-PO-AGE copolymer and the anion-containing salt having the fluoro group and the sulfonyl group (component (C)), the crosslinking agent, and the compatibilizing agent are kneaded at 200° C. to form the conductive thermoplastic elastomer composition of the first embodiment.

In consideration of handleability of the conductive thermoplastic elastomer composition at subsequent steps, the conductive thermoplastic elastomer composition of the first embodiment is pelletized.

A resin crosslinking agent or a peroxide is preferable as the crosslinking agent for dynamically crosslinking the EPDM rubber.

Halogenated alkylphenol is especially preferable as the resin crosslinking agent. The mixing amount of the resin crosslinking agent for 100 parts by mass of the EPDM rubber is set to favorably 5 to 15 parts by mass and more favorably 10 to 15 parts by mass.

To properly make a dynamic crosslinking reaction, zinc oxide may be added to the EPDM rubber as a crosslinking assistant together with the resin crosslinking agent. The mixing amount of the crosslinking assistant for 100 parts by mass of the EPDM rubber is set to favorably 0.5 to 10 parts by mass and more favorably 1 to 10 parts by mass.

It is preferable to use di(tert-butyl peroxy) diisopropyl benzene as the peroxide. The mixing amount of the peroxide for 100 parts by mass of the EPDM rubber is set to 0.5 to 3 parts by mass.

A co-crosslinking agent may be added to the EPDM rubber together with the peroxide. As the co-crosslinking agent, dioximes are favorable, and N,N′-m-phenylenebismaleimide is more favorable. The mixing amount of the co-crosslinking agent for 100 parts by mass of the EPDM rubber is set to favorably 0.1 to 5 parts by mass and more favorably 0.2 to 2 parts by mass.

Paraffin oil is favorable as the softener. Paraffin process oil is especially favorable.

The mixing amount of the softener for 100 parts by mass of the EPDM rubber is set to the range of 50 to 200 parts by mass and favorably 70 to 150 parts by mass.

It is preferable to use the peroxide as the crosslinking agent for dynamically crosslinking the EO-PO-AGE copolymer.

It is preferable to use the di(tert-butyl peroxy) diisopropyl benzene as the peroxide. The mixing amount of the peroxide for 100 parts by mass of the EO-PO-AGE copolymer is set to 0.5 to 3 parts by mass.

The co-crosslinking agent may be used together with the peroxide. As the co-crosslinking agent, the dioximes are favorable, and the N,N′-m-phenylenebismaleimide is more favorable. The mixing amount of the co-crosslinking agent for 100 parts by mass of the EO-PO-AGE copolymer is set to 0.1 to 5 parts by mass and favorably 0.2 to 2 parts by mass.

As the compatibilizing agent, ethylene-acrylic ester-maleic anhydride copolymer is preferable.

In the ethylene-acrylic ester-maleic anhydride copolymer, methyl acrylate or ethyl acrylate is used as the acrylic ester. It is favorable to use the ethyl acrylate. As the constituting ratio of the monomers composing the ethylene-acrylic ester-maleic anhydride copolymer, the content of the acrylic ester and that of the maleic anhydride are set to 3 to 10 mass % and 1 to 5 mass % respectively. In the above-described copolymer, the melt flow rate is set to favorably 0.5 to 100 g/10 minutes and more favorably 1 to 50 g/10 minutes.

The mixing amount of the compatibilizing agent is set to favorably 3 to 15 parts by mass and more favorably 5 to 10 parts by mass.

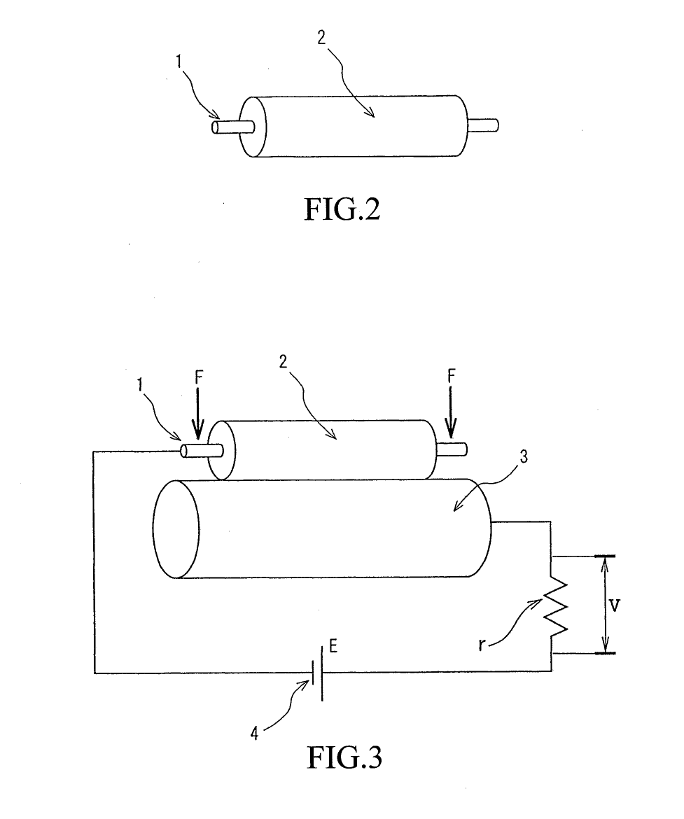

The conductive roller shown in FIG. 2 is produced by using the conductive thermoplastic elastomer composition formed by carrying out the above-described method.

The conductive roller 2 is composed of a cylindrical roller part consisting of the conductive thermoplastic elastomer composition having the above-described structure and a columnar shaft 1 inserted into the center of the cylindrical roller.

The thickness of the roller part is set to favorably 1 to 20 mm and more favorably 2 to 15 mm. If the thickness of the roller part is less than 1 mm, the roller part is insufficient in its elasticity. If the thickness of the roller part exceeds 20 mm, the conductive roller 2 is so large that it is difficult to mount the conductive roller 2 on a copying apparatus, a printer, and the like. The shaft 1 can be made of metal such as aluminum, aluminum alloy, SUS, and iron or ceramic.

It is possible to produce an approximately D-shaped rubber roller by inserting an approximately D-shaped shaft into the hollow portion of the cylindrically shaped roller part by press fit.

A coating layer (not shown) may be formed on the surface of the conductive roller 2. An oxide film may be formed on the surface thereof. The initial electric resistance value of the conductive roller when a voltage of 1000V is applied thereto is favorably 10⁶Ω to 10¹¹Ω and more favorably 10⁶Ω to 10⁹Ω and most favorably 10⁷Ω to 10⁹Ω.

The electric resistance ratio of the conductive roller 2 after the voltage is continuously applied thereto for 24 hours is set to not more than 2.5 and favorably not more than two.

The conductive roller of the second embodiment is described below.

The conductive roller 2 of the second embodiment is composed of a composition which is a mixture of 100 parts by mass of a conductive thermoplastic elastomer composition similar to that of the first embodiment and 0.5 to 5.0 parts by mass of micro-capsules each containing an acrylic group-containing polymer as the outer shell thereof.

It is preferable that the acrylic group-containing polymer forming the outer shell of the micro-capsule comprises an acrylic copolymer formed by polymerization of methacrylic acid or acrylic acid used as a monomer having carboxyl group.

The above-described micro-capsule is thermally expansive. More specifically, the outer shell of the micro-capsule envelopes liquid hydrocarbon as a low-boiling point substance.

The above-described micro-capsule has an expansion start temperature at not less than 110° C. and favorably in the range of 110 to 160° C. and more favorably 130 to 140° C. and a maximum expansion temperature in the range of 150° C. to 200° C. and favorably in the range of 180° C. to 190° C.

The conductive roller of the second embodiment is produced by the following method:

Micro-capsules and the conductive thermoplastic elastomer composition obtained by carrying out a method similar to that of the first embodiment are dry-blended by using a tumbler to obtain a composition composing the conductive roller of the second embodiment. Thereafter the composition is extruded tubularly at 150 to 210° C. by using a single-screw extruder. By inserting the metal shaft 1 into the hollow portion of the obtained tube by press fit or bonding the shaft 1 and the tube to each other with an adhesive agent, the conductive roller of the second embodiment is obtained.

In the conductive roller of the second embodiment, the particle diameter of the expanded micro-capsule is 100 to 500

A coating layer (not shown) may be formed on the surface of the conductive roller.

The Shore A hardness of the conductive roller of the second embodiment is not less than 10 nor more than 30 at 23° C., when the Shore A hardness is measured in accordance with JIS K 6253.

The conductive roller shows values falling within almost the same range as that of the conductive roller of the first embodiment in the initial electric resistance value thereof and the electric resistance ratio thereof after the voltage is continuously applied thereto for 24 hours.

In the conductive roller of the second embodiment composed of the conductive thermoplastic elastomer similar to that of the first embodiment, the micro-capsules (not shown) are dispersed in the continuous phase 11 shown in FIG. 1 in addition to the component (A). Therefore the conductive roller of the second embodiment is allowed to have a sufficiently low hardness, has an effect of sufficiently decreasing the electric resistance thereof. Further because the components are dispersed uniformly in the conductive thermoplastic elastomer composition, the conductive thermoplastic elastomer composition can be processed easily into the rubber roller. Therefore conductive thermoplastic elastomer composition composing the conductive roller is capable of contributing to excellent print of images at a low temperature as well as at a normal temperature without deteriorating the processability thereof.

Because the other constructions and effects of the second embodiment are similar to those of the first embodiment, the description thereof is omitted.

Examples of the present invention and comparison examples are described below.

### Example 1

The thermoplastic elastomer and the thermoplastic resin (component A), the EPDM rubber (component B), the softener, and the crosslinking agent were mixed with one another at the ratio shown in table 1 shown below. Thereafter the components were fused and kneaded at 200 rpm and 200° C. by using a twin-screw extruder (“HTM 38” produced by I-pec Inc.). After the component (B) was dynamically crosslinked with the crosslinking agent and extruded with the component (B) being dispersed in the component (A), the mixture was pelletized to obtain an elastomer composition (I).

The obtained pelletized elastomer composition (I), the EO-PO-AGE copolymer and the anion-containing salt having the fluoro group and the sulfonyl group (component C), the crosslinking agent, and the compatibilizing agent were mixed with one another at the mixing ratio shown in table 1 shown below. After the components were fused and kneaded at 200 rpm and 200° C. by using the twin-screw extruder (“HTM 38” produced by I-pec, Inc.) to dynamically crosslink the component (C) with the crosslinking agent and disperse it in the component (A). In this manner, the conductive thermoplastic elastomer composition of the present invention was obtained.

The obtained composition of the present invention was pelletized and supplied to a resin extruder (050 extruder produced by San.NT Inc.). After the composition was tubularly extruded at 20 rpm and 200° C., a shaft was inserted into the hollow portion of the obtained tube. Thereafter the tube was cut and polished to obtain the conductive roller of the present invention having a necessary dimension. The conductive roller had an inner diameter of 6 mm, an outer diameter of 14 mm, and a length of 218 mm.

In the obtained conductive roller, the mixture (component (A)) of the thermoplastic elastomer and the thermoplastic resin formed the continuous phase, whereas the EPDM rubber (component (B)) and the EO-PO-AGE copolymer containing the anion-containing salt having the fluoro group and the sulfonyl group (component (C)) were separately dispersed in the component A with the EPDM rubber and the EO-PO-AGE copolymer forming the first uncontinuous phase and the second uncontinuous phase respectively.

### Comparison Example 1

An elastomer composition (I) was obtained in a manner similar to that of the example 1.

Without using the crosslinking agent, the obtained pelletized elastomer composition (I), the EO-PO-AGE copolymer and the anion-containing salt having the fluoro group and the sulfonyl group (component (C)), and the compatibilizing agent were mixed with one another at the mixing ratio shown in table 1 shown below. After the components were fused and kneaded at 200 rpm and 200° C. by using the twin-screw extruder (“HTM 38” produced by I-pec, Inc.) to disperse the component (C) in the component (A) without dynamically crosslinking the component (C). In this manner, the conductive thermoplastic elastomer composition of the comparison example 1 was obtained.

The obtained conductive thermoplastic elastomer composition was pelletized to produce a conductive roller in a manner identical to that of the example 1.

In the obtained conductive roller, the mixture (component (A)) of the thermoplastic elastomer and the thermoplastic resin and the EO-PO-AGE copolymer containing the anion-containing salt having the fluoro group and the sulfonyl group (component (C)) formed the continuous phase, whereas the EPDM rubber (component (B)) formed the uncontinuous phase.

### Comparison Examples 2, 3

The thermoplastic elastomer and the thermoplastic resin (component (A)), the EPDM rubber (component (B)), the EO-PO-AGE copolymer and the anion-containing salt having the fluoro group and the sulfonyl group (component (C)), the softener, the crosslinking agent, and the compatibilizing agent were mixed with one another at the mixing ratio shown in table 1 shown below. After the components were fused and kneaded at 200 rpm and 200° C. by using the twin-screw extruder (“HTM 38” produced by I-pec, Inc.) to simultaneously dynamically crosslink the component (B) and the component (C) with the crosslinking agent and disperse them in the component (A). In this manner, the conductive thermoplastic elastomer composition of each of the comparison examples 2, 3 was obtained.

The obtained conductive thermoplastic elastomer composition was pelletized to produce a conductive roller in a manner identical to that of the example 1.

In the obtained conductive roller, the mixture (component (A)) of the thermoplastic elastomer and the thermoplastic resin formed the continuous phase, whereas the EPDM rubber (component (B)) and the EO-PO-AGE copolymer containing the anion-containing salt having the fluoro group and the sulfonyl group (component (C)) formed the uncontinuous phase. That is, one uncontinuous phase containing the component (B) and the component (C) was formed.

TABLE 1

| | | | E1 | CE1 | CE2 | CE3 |
|---|---|---|---|---|---|---|
| Kneaded | component A | Thermoplastic elastomer | 50 | 50 | 50 | 50 |
| components 1 | | Thermoplastic resin | 20 | 20 | 20 | 20 |
| | component B | EPDM rubber | 100 | 100 | 100 | 100 |
| | component C | EO-PO-AGE copolymer | — | — | 25 | 45 |
| | | salt | — | — | 2.5 | 2.5 |
| | | Softener | 100 | 100 | 100 | 100 |
| | | Crosslinking agent 1 | 1.7 | 1.7 | 1.95 | 2.15 |
| | | Compatibilizing agent | — | — | 8 | 8 |
| Kneaded | component C | EO-PO-AGE copolymer | 25 | 25 | — | — |
| components 2 | | Salt | 2.5 | 2.5 | — | — |
| | | Crosslinking agent 1 | 0.25 | — | — | — |
| | | Compatibilizing agent | 8 | 8 | — | — |

| Mass of composition | | 307.45 | 307.2 | 307.45 | 327.65 |
|---|---|---|---|---|---|
| Evaluation | Processability in extrusion | ◯ | ◯ | Δ | X |
| | Hardness | 48 | 46 | 52 | 58 |
| | Initial Electric Resistance Value (Ω) | 5.1 × 10⁸ | 1.3 × 10⁸ | 6.3 × 10¹¹ | 1.6 × 10⁹ |
| | Electric resistance ratio After Continuous | 1.8 | 3.8 | 1.2 | 3.4 |
| | Voltage Application for 24 Hours | | | | |

E and CE in the uppermost column indicate example and comparison example respectively.

The following products were used as the components shown in table 1.

Thermoplastic elastomer: hydrogenated styrene thermoplastic elastomer (“SEPTON 4077 (commercial name)” produced by Kuraray Co., Ltd.)

Thermoplastic resin: polypropylene (“NOVATEC PP (commercial name)” produced by Japan Polypropylene Corporation)

EPDM rubber: “Esprene 505AF (commercial name)” produced by Sumitomo Chemical Co, Ltd.

Softener: paraffin process oil: “DAIANA process oil PW-380 (commercial name)” produced by Idemitsu Kosan Co., Ltd.

Crosslinking agent 1: α,α-di(tert-butyl peroxy)di-isopropylbenzene (“PERBUTYL P (commercial name)” produced by NOF CORPORATION)

EO-PO-AGE copolymer: (“ZEOSPAN 8100(commercial name)” produced by Zeon Corporation)

Salt: bis(trifluoromethanesulfonyl)imide lithium

Compatibilizing agent: Ethylene-acrylic ester-maleic anhydride copolymer: “Bondine LX4110 (commercial name)” produced by Arkema Inc.

The properties of the conductive rollers of the examples and the comparison examples were evaluated by a test method described below.

Processability in Extrusion

The configuration (surface of rubber) of each tube was visually evaluated when the pellet of the composition composing each conductive roller was extruded tubularly by using the resin extruder.

◯: The surface of the tube is smooth and has no problems.

Δ: The surface of the tube is irregular to some extent but is acceptable by altering the extrusion condition and increasing a polishing area thereof.

X: The irregularity degree of the surface of the tube is so high that the surface is broken while the pellet is being extruded. Thus it is difficult to shape the pellet of the composition into a tube.

Hardness in accordance with JIS K 6253, the hardness of each conductive roller was measured at a constant-temperature and constant-humidity condition, namely, an atmospheric temperature of 23° C. and a relative humidity of 55%.

Measurement of Initial Electric Resistance Value

As shown in FIG. 3, the conductive roller 2 through which the shaft 1 was inserted was mounted on an aluminum drum 3, with the conductive roller 2 in contact with the aluminum drum 3.

The conductive roller 2 was rotated at 30 rpm with a load F of 500 g was being applied to both ends of the shaft 1. A leading end of a conductor having an internal electric resistance of r (1000) was connected to one end surface of the aluminum drum 3, with the leading end of the conductor connected to a positive side of a power source 4. A leading end of a conductor was connected to one end surface of the shaft 1 inserted through the conductive roller 2 with the leading end of the conductor connected to a negative side of the power source 4. A voltage of 1000V was applied to the conductive roller 2 in this state.

A voltage V applied to the internal electric resistance r of the conductor was detected. Supposing that a voltage applied to the apparatus is E, the initial electric resistance R of the conductive roller 2 is: R=r×E/(V−r). Because the term −r is regarded as being extremely small in this case, R=r×E/V.

The initial electric resistance value of each conductive roller 2 was measured at a constant-temperature and constant-humidity condition, namely, a temperature of 23° C. and a relative humidity of 55%.

Electric Resistance Ratio after Continuous Voltage Application for 24 Hours

After an initial electric resistance value R was measured, a voltage of 1000V was continued to be applied to the conductive roller with the conductive roller being rotated. An electric resistance value R₂₄ was measured by the same measuring method as that used to measure the initial electric resistance value, after the voltage of 1000V was continuously applied thereto for 24 hours. The electric resistance ratio after the voltage of 1000V was continuously applied to the conductive roller for 24 hours was computed from the obtained electric resistance value R₂₄ by using an equation shown below.

The electric resistance ratio after the voltage of 1000V was continuously applied to the conductive roller for 24 hours=R₂₄/R

In the conductive thermoplastic elastomer composition of the comparison example 1 in which the EO-PO-AGE copolymer was not dynamically crosslinked, and the EO-PO-AGE copolymer containing the anion-containing salt having the fluoro group and the sulfonyl group (component (C)) was contained in the continuous phase, the change in the electric resistance value of the conductive roller composed of the conductive thermoplastic elastomer composition was large in the continuous voltage application to the conductive roller.

In the conductive thermoplastic elastomer composition of comparison example 2 in which the EPDM rubber and the EO-PO-AGE copolymer were simultaneously dynamically crosslinked, and the EPDM rubber and the EO-PO-AGE copolymer containing the anion-containing salt having the fluoro group and the sulfonyl group (component (C)) were contained in the uncontinuous phase, the electric resistance value of the conductive roller composed of the conductive thermoplastic elastomer composition was high and the moldability of the conductive thermoplastic elastomer composition was low. In the conductive thermoplastic elastomer composition of the comparison example 3 in which the mixing amount of the EO-PO-AGE copolymer was increased to decrease the electric resistance value thereof, the electric resistance value thereof was not high but the moldability thereof was lower than that of the conductive thermoplastic elastomer composition of the comparison example 2. In addition, the change in the electric resistance value thereof was large in the continuous application of the voltage to the conductive roller.

On the other hand, the conductive thermoplastic elastomer composition of the example 1 in which the uncontinuous phase containing the EO-PO-AGE copolymer containing the anion-containing salt having the fluoro group and the sulfonyl group (component (C)) formed island structures in the continuous phase was excellent in the processability in extrusion. Thus the obtained conductive roller had a low electric resistance value and a small change in the continuous voltage application thereto.

### Examples 2 Through 4 and 6 Through 10

The thermoplastic elastomer and the thermoplastic resin (component (A)), the pelletized EPDM rubber (component B), the softener, a crosslinking agent 2, and zinc white were mixed with one another at the ratio shown in table 2 shown below. Thereafter the components were fused and kneaded at 200 rpm and 200° C. by using the twin-screw extruder (“HTM 38” produced by I-pec, Inc.). After the component (B) was dynamically crosslinked with the crosslinking agent and extruded, with the component (B) being dispersed in the component (A), the mixture was pelletized to obtain the elastomer composition (I).

The obtained pelletized elastomer composition (I), the EO-PO-AGE copolymer and the anion-containing salt having the fluoro group and the sulfonyl group (component (C)), the crosslinking agent 1, and the compatibilizing agent were mixed with one another at the mixing ratio shown in table 2 shown below. After the components were fused and kneaded at 200 rpm and 200° C. by using the twin-screw extruder (“HTM 38” produced by I-pec, Inc.) to dynamically crosslink the component (C) with the crosslinking agent and disperse it in the component (A). Thereby each conductive thermoplastic elastomer composition was obtained.

The pellet of the obtained conductive thermoplastic elastomer composition of the present invention obtained in this manner and micro-capsules were dry-blended by using a tumbler to obtain a mixture. Thereafter the mixture was tabularly extruded at 20 rpm and an extrusion temperature shown in table 2 by using the single-screw extruder (050 extruder produced by Sun NT Inc.), molding having outer diameter of 14 mm and an inner diameter of 6 mm was obtained.

A shaft was inserted into the hollow portion of each of the obtained tubes. Thereafter each tube was cut to obtain a conductive roller having a length of 218 mm.

### Example 5

Except that the conductive thermoplastic elastomer composition did not contain the micro-capsule, the conductive roller was obtained by carrying out a method identical to that of the example 1.

### Comparison Example 4

Except that the conductive thermoplastic elastomer composition did not contain the kneaded components 2,3 (component C, micro-capsule, crosslinking agent 1, and compatibilizing agent), the conductive roller was obtained by carrying out a method identical to that of the example 2.

### Comparison Example 5

Except that the conductive thermoplastic elastomer composition did not contain the salt, the conductive roller was obtained by carrying out a method identical to that of the example 4.

TABLE 2

| | | | E2 | E3 | E4 | E5 | E6 | E7 |
|---|---|---|---|---|---|---|---|---|
| Kneaded | component A | Thermoplastic elastomer | 50 | 50 | 50 | 50 | 50 | 50 |
| components 1 | | Thermoplastic resin | 20 | 20 | 20 | 20 | 20 | 20 |
| | component B | EPDM rubber | 100 | 100 | 100 | 100 | 100 | 100 |
| | Softener | | 100 | 100 | 100 | 100 | 100 | 100 |
| | Crosslinking agent 2 | | 12 | 12 | 12 | 12 | 12 | 12 |
| | Zinc White | | 5 | 5 | 5 | 5 | 5 | 5 |
| Kneaded | component C | EO-PO-AGE copolymer | 10 | 10 | 10 | 10 | 10 | 10 |
| components 2 | | Salt | 1 | 1 | 1 | 1 | 1 | 1 |

| | Crosslinking agent 1 | 0.1 | 0.1 | 0.1 | 0.1 | 0.1 | 0.1 |
|---|---|---|---|---|---|---|---|
| | Compatibilizing agent | 0 | 8 | 0 | 0 | 0 | 8 |
| Mass of conductive thermoplastic elastomer compositon | | 298.1 | 306 | 298 | 298 | 298 | 306 |
| Kneaded | Micro-capsule A | 0 | 0 | 0 | 0 | 0 | 10 |
| components 3 | Micro-capsule B | 5 | 5 | 10 | 0 | 1 | 0 |
| | Ratio of part by mass of micro-capsule to | 1.7 | 1.6 | 3.4 | 0 | 0.3 | 3.3 |
| | 100 parts by mass of conductive | | | | | | |
| | thermoplastic elastomer composition | | | | | | |
| Extrusion temperature (° C.) | | 180 | 180 | 180 | 180 | 180 | 180 |
| Evaluation | Processability in extrusion | ◯ | ◯ | Δ | ◯ | ◯ | ◯ |
| | Particle diameter (μm) of micro-capsule | 240 | 260 | 230 | — | 260 | 80 |
| | Hardness | 24 | 25 | 21 | 48 | 36 | 34 |
| | Evaluation of printing performance at | ⊚ | ⊚ | ⊚ | ◯ | ◯ | ◯ |
| | normal temperature | | | | | | |
| | Evaluation of printing performance at low | ◯ | ⊚ | ⊚ | X | Δ | Δ |
| | temperature | | | | | | |

E in the uppermost column indicate example and comparison example respectively.

| | | | E8 | E9 | E10 | CE4 | CE5 |
|---|---|---|---|---|---|---|---|
| Kneaded | component A | Thermoplastic elastomer | 50 | 50 | 50 | 50 | 50 |
| components 1 | | Thermoplastic resin | 20 | 20 | 20 | 20 | 20 |
| | component B | EPDM rubber | 100 | 100 | 100 | 100 | 100 |
| | Softener | | 100 | 100 | 100 | 100 | 100 |
| | Crosslinking agent 2 | | 12 | 12 | 12 | 12 | 12 |
| | Zinc White | | 5 | 5 | 5 | 5 | 5 |
| Kneaded | component C | EO-PO-AGE copolymer | 10 | 10 | 10 | 0 | 10 |
| components 2 | | Salt | 1 | 1 | 1 | 0 | 0 |

| | Crosslinking agent 1 | 0.1 | 0.1 | 0.1 | 0 | 0.1 |
|---|---|---|---|---|---|---|
| | Compatibilizing agent | 8 | 8 | 0 | 0 | 0 |
| Mass of conductive thermoplastic elastomer compositon | | 306 | 306 | 298 | 287 | 297 |
| Kneaded | Micro-capsule A | 0 | 0 | 0 | 0 | 0 |
| components 3 | Micro-capsule B | 5 | 5 | 16 | 0 | 10 |
| | Ratio of part by mass of micro-capsule to | 1.6 | 1.6 | 5.4 | 0 | 3.4 |
| | 100 parts by mass of conductive | | | | | |
| | thermoplastic elastomer composition | | | | | |
| Extrusion temperature (° C.) | | 140 | 220 | 180 | 180 | 180 |
| Evaluation | Processability in extrusion | X | X | X | ◯ | ◯ |
| | Particle diameter (μm) of micro-capsule | 200 | 190 | 230 | — | 250 |
| | Hardness | (27) | (27) | (18) | 50 | 26 |
| | Evaluation of printing performance at | — | — | — | X | Δ |
| | normal temperature | | | | | |
| | Evaluation of printing performance at low | — | — | — | X | X |
| | temperature | | | | | |

E and CE in the uppermost column indicate example and comparison example respectively.

Products used as the thermoplastic elastomer, the thermoplastic resin, the EPDM rubber, the softener, the EO-PO-AGE copolymer, the salt, the compatibilizing agent, and the crosslinking agent 1 shown in table 2 were similar to those of the examples 1 and the comparison examples 1 through 3.

The following products were used as the zinc white, the crosslinking agent 2, and the micro-capsule.

Zinc white: “Zinc White No. 1 (commercial name)” produced by Mitsui Mining and Smelting Co., Ltd.

Crosslinking agent 2: phenolic resin crosslinking agent (“TACKROL 250-111 (commercial name)” produced by TAOKA CHEMICAL CO., LTD.)

Micro-capsule A: “Matsumoto Micro-sphere F-100 (commercial name)” produced by Matsumoto Yushi-Seiyaku Co., Ltd.

Micro-capsule B: “Matsumoto Micro-sphere F-105 (commercial name)” produced by Matsumoto Yushi-Seiyaku Co., Ltd.

The processability in extrusion and printing performance of the conductive roller of each of the examples 2 through 10 and the comparison examples 4 and 5 at normal and low temperatures were measured. The hardness of each rubber roller and the diameter of the micro-capsule of each rubber roller were measured. Table 2 shows the results of the evaluation.

The method for examining the processability in extrusion and hardness of each conductive roller was similar to that carried out in the example 1 and the comparison examples 1 through 3. The diameter of the micro-capsule of each conductive roller was measured by the following method. The printing performance of each conductive roller was evaluated by the following test method.

The hardness of the rubber roller of each of the examples 8 through 10 was measured by using a short tube composed of the conductive thermoplastic elastomer composition because the conductive thermoplastic elastomer composition had a low processability in extrusion and could not be molded into a tube having a necessary length. The measured hardness of each of the examples 8 through 10 is shown in parentheses in table 2. Because the tubes of the examples 8 through 10 did not have the necessary length, the printing performance of the rubber roller of each of the examples 8 through 10 was not evaluated.

Diameter of Particle Diameter of Micro-Capsule

Before the shaft was inserted into the rubber roller, a tubular molding obtained by extrusion was cut, and a section of each tube was magnified by 200 times to observe it with a video micro-scope. The diameters of 100 micro-capsules were measured. The average value of the 100 diameters was computed.

Evaluation of Printing Performance at Normal Temperature

Each of the conductive rollers of the examples and the comparison examples was mounted on a laser printer (“Laser Jet 4050 (commercial name)” manufactured by Hewlett-Packard Development Company) as a transfer roller. Halftone printing was performed on 100 sheets of paper of size A4 (PPC paper produced by Fuji Xerox Office Supply Corporation) at a temperature of 23° C. and a relative humidity of 55%. Print made on the 100 sheets of paper was visually evaluated.

⊚: Defective print was not observed. Thus the print had no problems.

◯: Defective print was observed in one to two of the 100 sheets of paper. But the degree of defectiveness was so low that the defective print cannot be recognized unless the print was carefully checked. Thus the print had no problems.

Δ: Defective print was observed in 5 to 10 of the 100 sheets of paper. X: Apparent defective print was observed in almost all of the 100 sheets of paper.

Evaluation of Printing Performance at Low Temperature

Printing performance was evaluated in the same manner as that used at the normal temperature except that the temperature and the relative humidity were altered to 10° C. and 20% respectively.

The conductive thermoplastic elastomer composition of the comparison example 4 containing none of the EO-PO-AGE copolymer, the ionic-conductive salt, and the micro-capsule containing the acrylic group-containing polymer forming the outer shell thereof was superior in the processability thereof in extrusion but had a high hardness and did not have a sufficient effect of decreasing the electric resistance thereof. Therefore defective print was observed at normal and low temperatures.

The conductive thermoplastic elastomer composition of the comparison example 5 had a low hardness and was superior in the processability thereof in extrusion. Because the conductive thermoplastic elastomer composition composing the rubber roller of the comparison example 5 did not contain the ionic-conductive salt, the conductive roller had a high electric resistance value. Therefore defective print was made to a slight extent at the normal temperature, whereas a high extent of defective print was made at the low temperature.

In the conductive thermoplastic elastomer composition of the example 8 extruded at a low temperature of 140° C., the conductive thermoplastic elastomer composition of the example 9 extruded at a high temperature of 220° C., and the conductive thermoplastic elastomer composition of the example 10 containing as large as 5.4 parts by mass of the micro-capsules for 100 parts by mass thereof, tubes were broken while extrusion molding was being performed. But each conductive thermoplastic elastomer composition had a hardness below 30.

The conductive roller of the example 5 not containing the micro-capsule had a sufficient effect of reducing the electric resistance and a favorable printing performance at the normal temperature, but caused defective print at the low temperature because the conductive roller had a high hardness.

The conductive roller of the example 6 containing as small as 0.3 parts by mass of the micro-capsules for 100 parts by mass thereof and the conductive roller of the example 7 in which the particle diameter of each of the expanded micro-capsules was 80 μm had a sufficient effect of reducing the electric resistance and no problem in the printing performance thereof at the normal temperature, but caused defective print on 5 to 10 sheets of the 100 sheets of paper at the low temperature because the conductive roller had a high hardness more than 30 in the hardness thereof.

In the conductive rollers composed of the conductive thermoplastic elastomer composition of the examples 2, 3, and 4 to which the micro-capsules were added, the uncontinuous phase containing the EO-PO-AGE copolymer containing the anion-containing salt having the fluoro group and the sulfonyl group (C) which is the ionic-conductive salt independently formed island structures in the continuous phase. The extrusion temperature was set to 150 to 210° C. The particle diameter of each of the micro-capsules was set to not less than 100 μm. The conductive thermoplastic elastomer compositions could be extruded into the conductive rollers respectively. Each conductive roller has a sufficient effect of decreasing the electric resistance thereof. The components of each conductive thermoplastic elastomer composition were uniformly dispersed. Therefore the conductive rollers could be easily formed from the conductive thermoplastic elastomer compositions respectively and allowed preferable print to be accomplished at the low temperature as well as at the normal temperature.

What is claimed is:

1. A method for producing a conductive thermoplastic elastomer composition, comprising the steps of:
dynamically crosslinking a rubber component (B) containing at least one of diene rubber and ethylene-propylene-diene rubber separately from an ethylene oxide-propylene oxide-allyl glycidyl ether copolymer (C) containing an ionic-conductive salt in a composition (A) which is a mixture of a thermoplastic elastomer and a thermoplastic resin; and
dispersing said rubber component (B) separately from said component (C) in said composition (A).

2. The method according to claim 1, wherein said ionic-conductive salt is an anion-containing salt having a fluoro group and a sulfonyl group.

3. The method according to claim 1, wherein said composition (A), said rubber component (B), and a crosslinking agent are mixed one another to dynamically crosslink said rubber component (B) with said crosslinking agent and disperse said rubber component (B) in said composition (A) to form an elastomer composition (I), and
said obtained elastomer composition (I), said component (C), and another crosslinking agent are mixed with one another to dynamically crosslink said component (C) with said crosslinking agent and disperse said component (C) in said composition (A).
